(19) United States
(12) Patent Application Publication
(10) Pub. No.: US 2024/0378309 A1
(43) Pub. Date: Nov. 14, 2024

(54) METHOD AND SYSTEM FOR DATA IN USE SECURITY RISK REDUCTION

(71) Applicant: Sourav Sam Bhattacharya, Fountain Hills, AZ (US)

(72) Inventor: Sourav Sam Bhattacharya, Fountain Hills, AZ (US)

(73) Assignee: Sourav Sam Bhattacharya, Fountain Hills, AZ (US)

(21) Appl. No.: 17/803,194

(22) Filed: Apr. 11, 2023

(51) Int. Cl. G06F 21/62; G06F 21/60

(52) U.S. Cl. CPC G06F 21/6227; G06F 21/602

(57) ABSTRACT

This invention presents Application software driven Data in Use security risk reduction, by selectively protecting Application sensitive data, resetting Keys post breach, and minimizing Ciphertext exposure. Both sensitive data detection and protection are disclosed. Sensitive data detection includes direct lexical scan and indirect intermediate variables value capture. Protection includes Non-Invasive and Invasive Mitigation. Non-Invasive Mitigation discloses code Front & Tail Trimming, Secure Wipe, and code line gap determined encryption (after last use) & decryption (before next use). Invasive Mitigation discloses a total code redesign using dependency graphs, a local code lines swap, and a global code lines collapse. Single machine job shop scheduling results are upheld with I/O library serialization, within Application development environment. Shuffle (unshuffled) algorithm(s) for data masking (unmasking) are disclosed. Ciphertext exposure volume computation method is shown to determine optimum data protection (using either encryption, or masking).

List of Acronyms and Terminologies used are incorporated here. The Specification is structured as follows.
Section 1 presents the definition of Data in Use, and current industry solution to this problem and their deficiencies.
Section 2 presents the solution proposed by this Invention, a specific and unique set of techniques claimed in this Invention. The solution includes real-time decryption of the Memory, use of the sensitive data in arithmetic and logical operations, and re-encrypt/write back to Memory. Certain novelty is imposed to this solution, by minimizing repetitive DP and DUP, if the successive Use code lines are close enough making DP and DUP more expensive.
Section 3 further refines the solution by invasive mitigation, such as Code swap between successive lines to bring the Use lines closer. Code swap is a local operation, between adjacent code lines.
Section 4 is a generalization of Section 3. It makes the code restricting global, using the Collapse concept. It is also an invasive class of algorithm.
Section 5 presents a few simplistic non-invasive mitigation algorithms. In non invasive mitigation, no source code lines are altered.
Section 6 presents the most generalized and invasive mitigation, and relates the current problem to the Job Shop scheduling problem.
Section 7 presents how to detect and mitigate over intermediate variables which may receive copy of the sensitive data value.
Section 8 presents a generalization of Encryption and Data Masking, combined together, to be used depending on how much Ciphertext is released at each breach.
Appendix A presents an elaboration of the deficiencies in current industry approach.
Appendix B presents screen shots of the Tool, and sample code segments, as evidences of embodiment.
Appendix C provides Systems and Methods embodiment platform description, per Intellectual Property protection MPEP, Statutory and US Code requirements.
Appendices 1, 2 and 3 provide a traceability table between Claims and Specification, an explanation of the terms Swap and Collapse, and a list of Acronyms and Terminologies used.
All Appendices, A, B, C, 1, 2 and 3 are part of the Specification by reference, and are incorporated herewith.

### DESCRIPTION OF THE DRAWINGS

There are 28 Figures and 9 Tables described as follows.

FIG. 1. Accountability vis-à-vis Authority. Compliance Violation and Legal Dispute.

FIG. 2. Code level protection for “Data in Use”: Heap carrying data in two States.

FIG. 3. Detection Tool: Execution and Output.

FIG. 4. New exposure per (Decryption, Encryption) vis-à-vis Existing exposure reduction.

FIG. 5. Classification of Mitigation Approaches.

FIG. 6. Single Sensitive Data Use Pattern: Swaps to move irrelevant lines outside of the single sensitive data's Use windows.

FIG. 7. Pairwise Swap Algorithm-Move Upward.

FIG. 8. Pairwise Swap Algorithm—Move Downward.

FIG. 9. Approach to modify the Swap algorithms for two or more sensitive data.

FIG. 10. Taxonomy of Mitigation Algorithms.

FIG. 11. Front Pass Clustering Algorithm.

FIG. 12. Comparison between the Front Pass and Rear Pass Algorithms.

FIG. 13. Birth, Use and Death of Sensitive Data.

FIG. 14. Just-in-Time Read of Sensitive Data.

FIG. 15. Expedited Death of Sensitive Data.

FIG. 16. Secure Wipe of Sensitive Data.

FIG. 17. An example Program Dependency Graph (PDG). @ Researchgate.

FIG. 18. Overall Programming Construct—Development Paradigm.

FIG. 19. Operating methods with intermediate variables that carry sensitive data.

FIG. 20. Exposure Volume (EV)=Snapshot Size x Duration.

FIG. 21. Data in Use: Use Cases for single threading and multiple threading.

FIG. 22. Data at Rest Use Cases.

FIG. 23. Data in Motion Use Cases—with widely varying EV ranges.

FIG. 24. 2 Tiers of Exposure Volume: Justifying two categories of Crypto solution.

FIG. 25. Scope of cryptographic solutions-‘Now’ versus “Should be”.

FIG. 26. Data Protection Method Algorithms and Key Construction.

FIG. 27. Unique Attributes of Heap Data Exposure and Effectiveness of Cryptanalysis. Figure B-2. Detection Tool Architecture.

Table 1. Summary deficiencies in the two current industry practices for Memory protection. Table 2. Various Compliance and Legal Violations due to Data in Use breach. Table 3: Average volume of data in a Hard Drive at the time of loss. Table 4. OWASP Top 10: Between 2017 and 2021. Table 5: Pseudo Code for Just-in-Time Read. Table 6: Pseudo Code for Expedited Death. Table 7: Pseudo Code for Secure Wipe. Table 8: Pseudo Code for Code Reshuffle—Attack Surface Reduction. Table 9. Masking and Unmasking Algorithms.

### 1. Current “Data in Use” Protection R&D and Deficiencies

Data in Use refers to the data in computer memory (heap or stack or equivalents). If the data being used is a sensitive data, then its (albeit, temporary) footprint at the memory can be exploited for security breach. This invention focusses at the Data in Use security risk issues.

We compare the current industry approach to Data in Use security risk protection methods with (a) Hardware based encryption approaches (Sections 1.1, 1.2), (b) CPU and Kernel based encryption approaches (Section 1.4). Compliance violations, legal and statutory deficiencies, and inability to accurately implement Security Controls are presented in Sections 1.1, 1.2, and 1.3 respectively.

Table 1: Deleted. See Drawings file for Table 1.

Data in Use security protection (“Issue 1”) has been dealt with Data at Rest security measures (“Issue 2”), by mapping the former to the solution available for the latter. When an attacker attacks the Application, the Application is likely to abort and write its Heap onto the local Hard Drive (HD). The copy of the Heap, at the HD, may be encrypted at the HD, providing a safeguard against data leakage from the HD.

While conceptually simple and effective, this is an ill balanced and incorrect approach to solve complex Engineering problems-because the resolution of one issue (“Issue 1”) is not being directly solved, instead the resolution is deferred to the solution available for a downstream issue ('Issue 2″). This is also a violation of the Defense in Depth principle, which requires a defense to be provided for the earliest point of intrusion, instead of perpetuating the issue and compensating downstream.

This deficiency leads to a number of problems, both technically and legally.

### 1.1 Compliance Violation: Technical Deficiency and Legal Disputes

Technical Deficiency: whose Key should be used to safeguard the Data (“in Use”)? Who owns this data? Is it (Interpretation 1) the User who is running the Application, or the (Interpretation 2) Admin of the Application who owns the Application, or the IT Security dept (Interpretation 3) of the Organization (e.g., the CISO) who owns all Assets' data security issue. Or, is it someone else?

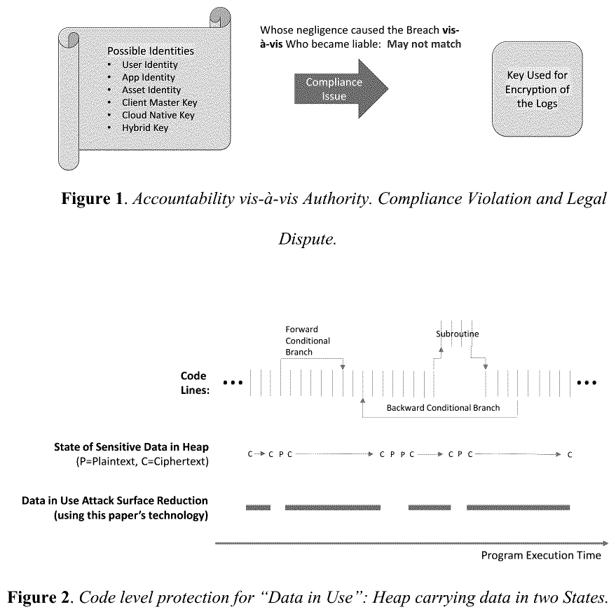

In the current industry solution, the Data (in Use), once written from the Heap onto the HD, is not being protected by anyone of the above 3 Key owners. Instead, the HD encryption is per the Key of the HD asset owner, such as the User who owns the laptop or the server (or the DBA if it is a DB storage). One may argue that the Key of the HD asset owner has a dotted line mapping to the CISO, as all assets are eventually mapped to the IT Security dept (NB: this argument fails for Bring Your Own Device [BYOD] devices). Even with such an argument, neither the App Admin nor the User who is running the Application have any control over the Key that is used to protect the data. This ambiguity is shown in FIG. 1.

FIG. 1: Deleted. See Drawings file for FIG. 1.

Legal and Compliance Question: From the technical question stated above, the Legal and Compliance question is-in the event of a breach, who is accountable? The User who lost her/his data, or the Application whose usage was compromised, or the Asset owner or the IT Dept? Disassociation of Accountability (for a Data Loss) and Authority (whose Data it is, who should have the authority to take sufficient protections to safeguard the data)—is an well known legal dispute between who suffered the loss versus who becomes responsible.

The above stated Legal and Compliance question, in addition to being quite a common sense fiasco and apparently obvious, is mapped to specific languages of compliance violation and then Statutory violation, as shown below in Table 2 (see Appendix A for language recital and explanations).

A key point to observe is how close, if not exact, [a] the role of the HD owner becomes that of a Property Thief (data being intangible property), [b] the role of the IT Dept (CISO) becomes that of an Accessory to the Theft crime (if the CISO makes the claim that the CISO delegated authority to the HD owner to hold or safekeep the User data, without an explicit written consent from the User (who owns the data), and [c] ineffectiveness of sign-in time click consent provided by the User, as the consent would be viewed as a good faith approval, and not to be exploited for specific data ownership re-assignment from the User owner to the HD owner.

The argument presented in this invention—is that—it is safer, cleaner and desirable to let the rightful owner of the Data, namely the User, control the safekeeping of his/her own Data—instead of—the current practice of—delegating the safekeeping authority to the HD owner, and consequently face all these legal and compliance disputes.

Table 2: Deleted. See Drawings file for Table 2.

All of these violations are rooted to a simple engineering mishap, that the owner of the Data (the User or the Application) is not rendered with the ability to protect his/her data. In the legal dispute, the Real Party in Interest (i.e., the User) would have a Claim against the Party who failed to protect the data, namely the HD Asset owner.

The problem is further compounded when the underlying platform is not On-Prem, but Cloud hosted. With Cloud hosted platform, the Cloud is storing the Logs. Whose Key should be used to protection, Cloud's own operational or Admin key, or the Client master key, or a hybrid? Although, the Service Agreement between Cloud platform stakeholders and the Client may have several indemnities, the end question of who suffered the data loss versus who did not take sufficient measures to prevent from the data loss-remains.

The technology solution presented in this invention circumvents this problem, by providing technology directly in the hand of the Application developer (aka, the User) who can protect his/her data as required.

The data owner thus becomes the data protector, eliminating the legal disputes and compliance violations.

### 1.2 Compliance Violation: Key Reset Policies

The next problem arises from the Key reset policies. Key reset is a critical compliance directive. Different types of Keys (for different Identities) undergo different reset policies. User Identities undergo a fixed time period based (e.g., 60-day) Key reset. Whereas, App Admin may undergo a different Key reset policy, as the Admin account may be a Service Account. Whereas, the HD Asset Key (such as the Bitlocker Key) may never be reset on a time rotation basis, instead the Bitlocker Key may be reset only post a HD asset loss of compromise.

This disparity, in Key reset policies, create another Compliance violation. The data owner (User Identity) would expect a Key reset on a predictable and preset time period. Whereas, the data protector (the laptop owner, whose Key is being used by Bitlocker) may not have reset it's Key as the laptop HD may not have been lost or stolen in several years. In the event of a breach, the dispute re: “why wasn't the Key reset periodically” (as the User Identity would expect) will lead to a Compliance violation.

While there is no set standard for BitLocker to periodically reset its key, an internet search led to the following result

The Application (and, hence the User running the Application with User's own data) may undergo repeated crashes, due to repeated security attacks. Each one of these crashes will lead to a Heap dump onto the HD. One would expect, that post each breach, the Key of the HD encryption should change. But, the HD encryption key may never change, as the HD encryption key is designed to change only after the HD is compromised. Unless compromised, the HD will keep on preserving potentially 100's or 1000's of Heap dumps, each providing valuable Ciphertext to the attacker. If the Keys were changed post each breach, the ciphertext available to the Attacker would only be for ONE security breach, and not a cascade of 100's or 1000's of breaches.

### 1.3 Ease of Cryptanalysis: Helping the Attacker and Harming the Data Owner

The next deficiency is how the HD that stores potentially a large number of Heap dumps aids to Cryptanalysis. The expectation, that post each Breach the Key shall be reset, is not maintained at the HD encryption key stage. Therefore, the HD (when it is stolen or compromised) is found with a large, and sometimes very large number of Heap core dumps—instead of one Heap dump.

Finding a large or very large sample of Ciphertext makes the cryptanalysis mush simpler, than if the HD had only one Heap dump. Thus, current industry practice helps the Attacker, and harms the Data owner. With one Heap dump, cryptanalysis may even not be feasible, as one Heap instance may resemble the “one time pad” characteristics of cryptography. Table 3 shows summary stats of how much data a typical encrypted HD asset may contain. The larger this number is, the more is the volume of the Ciphertext, and the easier it would be to Cryptanalyze and break the encryption.

Table 3: Deleted. See Drawings file for Table 3.

With this invention's proposed technology, the Application is directly in charge of selecting and resetting the encryption Key. Therefore, post a Heap dump, the Application can and will change its Key. There shall be no Key level correlation between the Heap dump instance 1 and Heap dump instance 2. This makes the task of the Attacker (i.e., Cryptanalysis) harder, and the task of the Data owner (who designs and uses various encryption algorithms) easier.

### 1.4 CPU and Kernel Level Memory Encryption

Securing the memory at Kernel level has been addressed by AMD and Intel CPUs [10]. These works are complimentary to our research, but not competitive. They share the same goal, as protection of the data. But, they address a different time segment of the problem, namely when the data is resting (at the memory), whereas the problem we address is when the data is being used. By encrypting the computer memory, what is accomplished (by the Intel and AMD CPUs) is protection of the memory from attacker's access. This protection will essentially provide another form of Data at Rest protection, where the data is resting at the memory.

The problem addressed by CPU and Kernel level encryption is Data at Rest protection, and not Data in Use protection. Data in Use occurs as and when the said memory will require to participate in a computer program, when the program will read the sensitive data, operate upon the sensitive data, and then write the sensitive data back into the memory, for a subsequent access from another part of the program. During these Data in Use steps, encrypting the memory at Kernel level of by CPU hardware is not applicable, as the Data must be able to participate in computer program's arithmetic and logical operation, and hence be available in Plaintext.

There are other key differences between the CPU & Kernel level encryption [ref1] and our work. These differences are as follows:
A. The Application software can selectively protect only the sensitive data, instead of every data. This is beneficial from performance perspective.
B. The Application software encrypts and decrypts using software library, as opposed to Kernel provided default steps. The former (software controlled libraries) can be omitted, when successive code line all use the same data, making it economical to retain a Plaintext version of the data in the Heap for a short period of time. Whereas, the same code lines' execution with Kernel level encryption will default encrypt each and every access, providing no room for optimization.
C. Similar, if not identical comparison can be made regarding local pairwise swapping code lines or global collapse of the code lines, as proposed in this invention. The entire research to maneuver the code lines to reduce the overhead of encryption and decryption becomes not applicable, when the CPU and Kernel are default implementing encryption and decryption of every data in and out of the physical memory.
D. Last, but not the least, the Kernel level encryption and decryption provides no room to pick and choose between either cryptographic solution or data masking solution. Whereas, our software controlled data protection provides this flexibility.

### 1.5 Other Prior Art Comparisons

Data in Use security solutions are seldom noted, from a software perspective. An analyst reference regarding this matter had led to no prior results reported.

While source code scanner is overwhelmingly common and popular, the category of security issues and exposure from Data in Use has/have not been addressed in the commercial source code scanners.

Likewise, the OWASP community [7], as well as MITRE CWE [8] and NVD (National Vulnerability Databases) have not addressed the Data in Use class of attack surface issues from a code level solutioning perspective. See for example OWASP top-10 vulnerabilities for 2017 and 2021, shown below (Table 4) and the mapping between them. None of these vulnerabilities address Data in Use exposures and attack surfaces. One may argue that the OWASP A04 Insecure Storage is a broad category for the same, but it is too broad and is not specific to Data in Use. Plus, it is a security defect category, it does not specify what the source code should or should not do to reduce the Data in Use risk or attack surface.

Likewise, CWE 244 is a category for Heap storage security breaches, however, how to resolve the Heap getting sensitive data in the first place from the source code (which is the focus of this invention) remains non-specific. The solution (for Data in Use) security breaches from a source code perspective remains unaddressed.

Table 4: Deleted. See Drawings file for Table 4.

Data in Use security issues are studied in the context of Heap Security, where the research community has recognized the Risks and Exposure from sensitive data residing in the Heaps. See [1, 2]. Several Operating Systems level protections of memory have been proposed, e.g., on Windows systems the VirtualLock function can lock a page of memory to ensure that it will remain present in memory and not be swapped to disk [5]. However, Heap is not the only place where Data in Use breaches may occur. Log files as well as core dump of stack traces are equally vulnerable spots for Data in Use breaches. Furthermore, the treatment (prevention or reduction) of Data in Use breaches are not focused at the source code level, instead they focus on better management of the Heap.

Data Security has been extensively addressed, with primary focus being Data in Motion and Data at Rest securities. Data in Use is relatively less addressed. Breaches due to Data in Use are captured as part of the Data Loss Prevention (DLP) technologies, often embodied in Hard Drive Encryption (e.g., Bit Locker [3]). One way to view the current invention is that it is an approach to a software based solution to the DLP problem. Another way to view the current invention is that it is an approach to prevent the Heap (or, other memory or disk mapped version of memory) to keep getting footprint of the sensitive data in the first place.

### 2. Invention: Code Level Protections for “Data in Use” Security

This invention presents technology solution to the deficiencies presented in Section 1. The technology permits the Application to directly protect its sensitive data with the use of Encryption or Data Masking or other approaches (instead of relying on a downstream artifact such as the Hard Drive with HD's own encryption). The selection of the specific approach (to encrypt or data mask) is a decision taken by the Application and User of the Application.

The Heap carries the sensitive data, as is the fundamental computing model. However, depending on the time instant, the Heap either carries [State P] a Plaintext version of the sensitive data, or [State C] a Ciphertext version of the sensitive data.
The State C is when the sensitive data is not being explicitly used in an arithmetic or logical computing step.
Whereas, State P is when the sensitive data is being part of a computation of control flow logic operation. See FIG. 2.

FIG. 2: Deleted. See Drawings file for FIG. 2.

One expects “State C” as the majority of the execution time span of the program, and “State P” as the minority or lesser of the time period. A security attack during “State C—time span” causes no Data loss, since the Heap has a Ciphertext version of the data. Whereas, a security attack during “State P—time span” may disclose the Plaintext onto the Heap (which in turn would be protected by HD protection, like in the current industry practice, see Sections 1.1, 1.2), but the State P time span is much smaller compared to State C time span.

### 2.1 Basic Computing Model: Plaintext Exposure is a Must for Arithmetic and Logical Operations

The basic computing model (around a specific data, which could be any data, but for our focus these are Sensitive Data) includes an Add, a NOT or complement, and a Jump-conditional. (All other execution steps can be built on top of these 3instructions, which is outside the scope of this invention, but is a basic result in Automata theory.) To execute these instructions, one cannot operate on the data in Ciphertext, instead the data must be in Plaintext¹. ¹This is an area of research in Cryptology. If encryption algorithms can be developed that can permit correctness preserving Addition, Complement and Logical operations all in the Ciphertext space (without having to first convert the data to Plaintext to be able to carry out the respective operations in Plaintext space) then the Heap can store Ciphertext always, and the sensitive data can be 100% safe as it would never have to be converted to Plaintext. This topic, an interesting research area in cryptology, is outside the scope of this invention.
Indeed, “Not[Encrypt (Value)]” is not the same as “Encrypt[Not (Value)]”.
“Encrypt(Value 1)+Encrypt(Value 2)” is not=“Encrypt(Value 1+Value 2)”.
“Value 1>Value 2” does not make “Encrypt(Value 1)>Encrypt(Value 2)”

To carry out the program's intended arithmetic and logical operations, the program must operate on Plaintext version of the variable, and cannot expect to operate on the Ciphertext version of the variable. Exposure of sensitive data in Plaintext during those specific FLOPs computation steps (when the sensitive data is being operated with arithmetic and logical operations) is inevitable. This is a theoretical limitation, and cannot be avoided.

### 2.2 Opportunity for Plaintext Life Span Reduction

However, when the program is not explicitly operating any arithmetic or logical operation with the sensitive data, then there is no reason to keep the sensitive data laying around in Heap in Plaintext format. The program can, immediately after a sensitive data has been operated with required arithmetic and logical operations, convert the sensitive data from Plaintext to Ciphertext. Then after some time in the code, when the same sensitive data is needed again for another arithmetic and logical operation, the code can decrypt and convert the data from Ciphertext to Plaintext.

This process of toggling back and forth, between Plaintext and Ciphertext is the opportunity for Attack Surface Reduction for Data in Use. This opportunity must be traded against the cost of exploiting such opportunity, which the below subsection further elaborates.

This is a key idea this invention proposes, with of course a large number of unique optimizations built in combination with this idea.

### 2.3 Specificities of Detection Methods: Lexical occurrence and Category

Detection of Sensitive Data variables are purely a Lexical operation, i.e., a String search. Given one or more sensitive data names, our tool scans the input program to detect all Lexical occurrences of the sensitive data names. The output of the Detection phase consists of:
Line numbers of Occurrence
Usage Type (such as Initialization, Declaration, Read or Write)

It is critical to distinguish between Declaration and Initialization, as Declaration does not assign any value to the sensitive date, while Initialization may do so. Plaintext to Ciphertext conversion is needed only after the sensitive data has obtained a value.

While scanning for sensitive data, our Tool also searches for other variables that may receive a value of the sensitive data. For example, if Account_No is a sensitive data, and Temp_Account is an intermediate variable, and if there is an instruction Temp_Account=Account_No then
Account_No is a native sensitive data
Temp_Account is a derived sensitive data
   Our tool implements a multi-pass Lexical scanning² operation, as follows: ²While Detection of Sensitive Data is a precise and deterministic operation, detection of intermediate variables that may from time to time carry sensitive data values may not be precise, and may be non-deterministic. A key ambiguity arises as the naming of the intermediate variables may be run-time constructed and hence not statically known for lexical match. See Section 7, 7.4 in particular for details.
1^{st} Pass scanning (Lexical): All (native) Sensitive data occurrences and Categorization (Init, Decl, Read, Write) are spotted.
2^{nd} Pass scanning (also, Lexical): All (derived) Sensitive data occurrences and Categorization (Init, Decl, Read, Write) are spotted.
There could be a transitive relationship amongst Sensitive Data

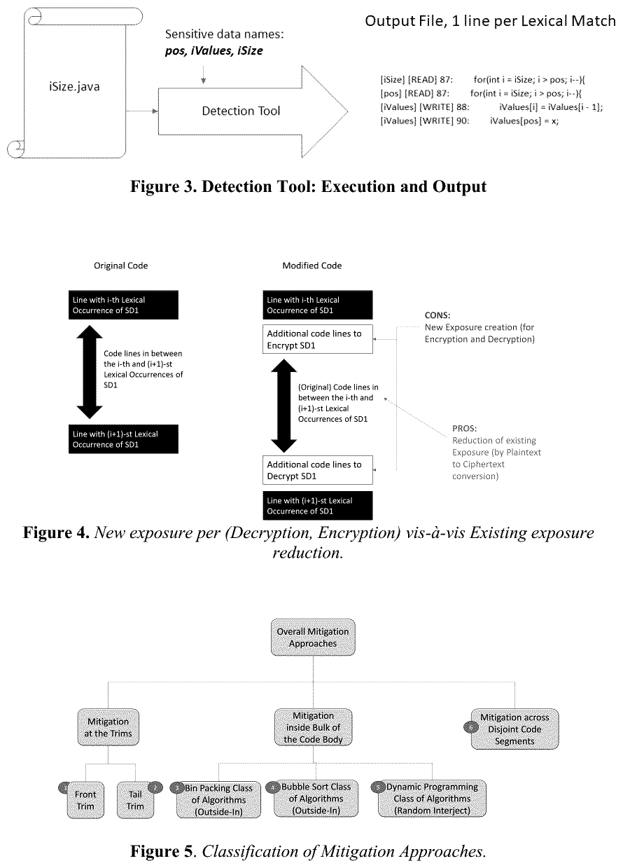

FIG. 3 below shows a sample screen shot output from the Detection Tool written in Python (more details on the Tool are provided in Appendix B.) An input program named iSize.java was provided, and sensitive data names iValues, iSize and pos were provided. The Detection tool generated a search output a part of which is shown below. At line 87, there are two Read operations, one for pos, and the other for iSize. At line 88, there is a Write for iValues[] and likewise another write for iValues[] at line 90.

FIG. 3: Deleted. See Drawings file for FIG. 3.

### 2.4 Mitigation Approaches: From Naïve to Progressively More Powerful

The Detection Tool reports every Lexical occurrence of a sensitive variable. Suppose, SD₁ is a sensitive data name. The Detection Tool output can be symbolically represented as a String of 2-tuples, where Lᵢ is the line no, and codeᵢ is the code line at that line number where the sensitive data SD₁ is lexically matched.

```
    [ (L₁, code₁), (L₂, code₂), (L₃, code₃), ... , (Lₘ, codeₘ) ]
Per Figure 3, for SD₁ =iValues
the Detection Tool output can be represented as
  [ (88, “iValues[i] = iValues[i−1]”), (90, “iValues[pos] = x”) ]
```

The simplest and the most naïve Mitigation would be when for every Lᵢ two new lines of code are inserted-one at the immediate previous (to Lᵢ) line with “Decrypt (SD₁)” and another at the immediate successor (to Lᵢ) line with “Encrypt (SD₁). This would make the code represented as

| | |
|---|---|
| [ ... | (old Lᵢ₋₁, codeᵢ₋₁), |
| | (new Lᵢ − 1, Decrypt(SD₁)), (Lᵢ, codeᵢ), |
| | (new Lᵢ + 1, Encrypt(SD₁), |
| | (old Lᵢ₊₁, codeᵢ₊₁) ] |

However, this approach may not be optimum. If the code line (in FLOPs) distance between any pair of successive (i, i+1) Lexical occurrences is less than the FLOPs requirement for “Encryption +Decryption” then encrypting immediately after the previous line occurrence and decrypting immediately before the next line occurrence may be wasteful, failing to reduce any Data in Use attack surface exposure. The process of Encryption and Decryption may create new Data in Use exposure cancelling any reduction of Data in Use exposure reduction between i^{th} and (i+1)^{st} Lexical occurrences of the sensitive data SD₁. FIG. 4 shows this tradeoff pictorially. This is the “code lines Gap driven selective insertion of encryption after the last Use and decryption before the next Use” idea proposed in this invention.

FIG. 4: Deleted. See Drawings file for FIG. 4.

If two or more lines (all lexically matching with SD₁) are close enough, it may be more secure not to encrypt and decrypt the sensitive data repeatedly between those close by lines.

Therefore, a code structural analysis is required to optimally place the Encryption and Decryption new lines of code. See Subsection 2.5 below for 3 classes of algorithms-Bin Packing, Bubble Sort and Dynamic Programming (Random Injection), to do so.

### 2.5 Taxonomy of Mitigation Techniques (Using In-Line Code Encryption and Decryption)

The opportunity (of Encrypting immediately post Use, and Decrypting immediately pre Use) to reduce the Data in Use attack surface, with the caution that the cost of Encryption and Decryption may introduce new Data in Use attack surfaces and may therefore outweigh the benefits-this tradeoff (between the “opportunity” and the “caution”) is navigated by a number of Mitigation algorithms designed in our research. The classification tree is shown in FIG. 5.

FIG. 5: Deleted. See Drawings file for FIG. 5.

Front and Tail Trims: Mitigation can be at the Trims, either front of tail end of the code. These are marked as “1” and “2” in FIG. 5. These Mitigation techniques are the simplest and yet may be the most beneficial. These techniques exploit the observation that a large code body (N lines) may use only a small fragment of code lines (M lines) specific to sensitive data, with M<<N. Therefore, it is likely that a significant part of the code exists completely unrelated to the sensitive data either before the very first use (hence, the naming “front Trim”) of the sensitive data, or after the very last use (hence, the naming “tail Trim”) of the sensitive data. Removal of the sensitive data at the Trims may provide the easiest and most effective data attack surface reduction.

Disjoint Code Segments with respective Sensitive Data: This is marked no “6” in FIG. 5. This approach looks for opportunities where two or more sensitive data (and their associated code) may have been stapled together in a code body by the developers, with no interactions between the respective code lines. If so, it is indeed an easy opportunity to partition to code body into two or more code segments, and contain one sensitive data within its own segment and not even upload the said sensitive data in other code segments. This approach uses a simple Graph partitioning technique.

Inside Bulk of the Code Body: This is the most complex and the largest class of Mitigation algorithms. It includes three methods—“Inside out”, “Outside in” and “Random interject”—which are marked as “3”, “4” and “5” respectively.
Bin packing class of algorithms (marked no “3”) conceptually visualize the cost of Decryption+Encryption (D+E) as a BIN. This BIN is the exposure (in FLOPs) that is incurred by default when an Encryption is made protecting the Plaintext into Ciphertext, and later a Decryption is made recovering the Ciphertext into Plaintext. This BIN is a fixed cost. The optimization objective is-how many lines of code (relevant to the sensitive data) can be packed in successive or adjacent lines of code which fit inside this BIN dimension in FLOPs. The higher, the more desired is the outcome. In the best case, all the lines specific to a particular sensitive data are perfectly sequenced in a contiguous flow lines of code, with a single entry and single exit. In that case, the BIN is maximally used, and only 1 decryption at the commence of the BIN and 1 encryption at the end of the BIN would suffice.
Bubble Sort class of algorithms (marked no “4”) conceptually visualizes the Mitigation optimization as iteratively swapping two successive Lexical occurrences of the sensitive data, to bring them closer. As an example, a sensitive data matches at line no 200 and then next at line no 240. The Gap between them is 40 lines of (unrelated to the sensitive data) code. These 40 lines of code is an undesired element of the code structure. Is it possible to swap lines 240 and 239, and if so this Gap will reduce to 39 instead of 40. Is it further possible to swap lines 239 (which was line 240 previously) and 238? If so, the Gap reduces to 38. Can this process be continued for more and more pairwise swap of code lines, bringing the Gap to a lower value. This is the way a bubble sort algorithm works, by iteratively pushing the values, one step at a time closer towards the end result. At each swap there is a criteria, to determine if the swap is feasible, and if so, whether implementing the code lines pair swap would reduce the Data in Use attack surface reduction.
Random Interjection class of algorithms (marked no “5”) visualized the entire code span (line no 1 to the line no last, total N lines of code) as a target space to interject (aka. throw and pack) the (M) lines of code relevant to a sensitive data. The algorithm attempts to identity one or a few (as small as possible) sections of this target space to throw in and pack the M lines of code anywhere in the target space of N lines of code. This packing must be done while being consistent to the Program Dependency Graph (PDG, a combination of Data Flow Graph and Control Flow Graph) specific to the sensitive data. The algorithm is iterative, and at each step it interjects 1 node of the PDG graph into a specific segment of the N lines of code. The node of the PDG graph is a matter of abstraction, and the designer can play with how many of the M lines of code constitute one node of the PDG.

### 2.6 Cryptanalysis Impact: Reduced and Usually 1—Copy of Ciphertext

When a security Attack is encountered and the Heap dumps its contents to the HD, a single time instant snapshot of the Heap would be written onto the HD. If a particular sensitive data (SD₁) has had one or 1000s of Lexical occurrences, it would not reflect the end Heap dump—there will be only one value of SD₁ that would be written onto the HD. However, which point in time's value of SD₁ would be written—that may change. SD₁ may be found in Plaintext, at the time of attack, which is rare but may happen if the Attack time matched exactly when SD₁ was being operated for arithmetic and logical operations and hence SD₁ was in Plaintext in the Heap (unfortunately, but inevitable). Or, SD₁ may be found in Ciphertext at the time of attack, depending on which Lexical line was being executed at the time of attack.

Therefore, SD₁'s exposure is either ONE Ciphertext instance, or the Plaintext itself. The Plaintext option is out of our scope, as that is protected at the HD encryption, which is the current industry practice. (We can also consider an extreme case, where all Lexical Occurrences do undergo the (Decyrpt, Use, Encrypt) option, in which case there will be no Plaintext in Heap, unless within the D+E FLOPs window itself.) But, the Ciphertext option is more practical and likely to happen. It shows that the Cryptanalyst will only get ONE Ciphertext instance, which is often not enough to break the code.

The consequence of this finding is that—using our proposed technology (of in-line encryption and decryption)—the burden on the Attacker, i.e., cryptanalyst is much higher and often impossible. Indeed, if the Attacker can only get 1 Ciphertext instance, is it not as impossible to break-in as “one time pad” is.

This finding may permit usage of cheaper and simpler encryption algorithms, such as Substitution Cipher or Transpose Cipher, or even data masking solutions or Obfuscation. These are algorithmically less expensive to execute, making the D and E values lower, and also the Storage space requirements being less.

See Section 8, 8.7 in particular for a detail discussion.

### 3. Pairwise Swap Based Algorithms (Invasive Mitigation)

This section presents the most basic form of Clustering algorithms (for Invasive Mitigation to reduce Data in Use Risk), where the Clustering is a local pairwise swap.

This type of clustering is not as complex as a global clustering algorithm or heuristics. It operates on a simple pairwise swap policy, which is a rudimentary form of local clustering. But, this rudimentary form of local clustering is a well known and well practiced concept in Computer algorithms, namely in Bubble Sort.

We are deploying the same bubble sort class of operation, except of course the concept of “numerical ascent or descent” is amiss in the current context. Instead, the context is bringing Use (of the sensitive data) lines closer along the lines of code, to reduce the number of potentially repetitive encryption and decryption one may have to deploy, in the context of Heap encryption and Data in Use Risk reduction.

### 3.1 Visual Model

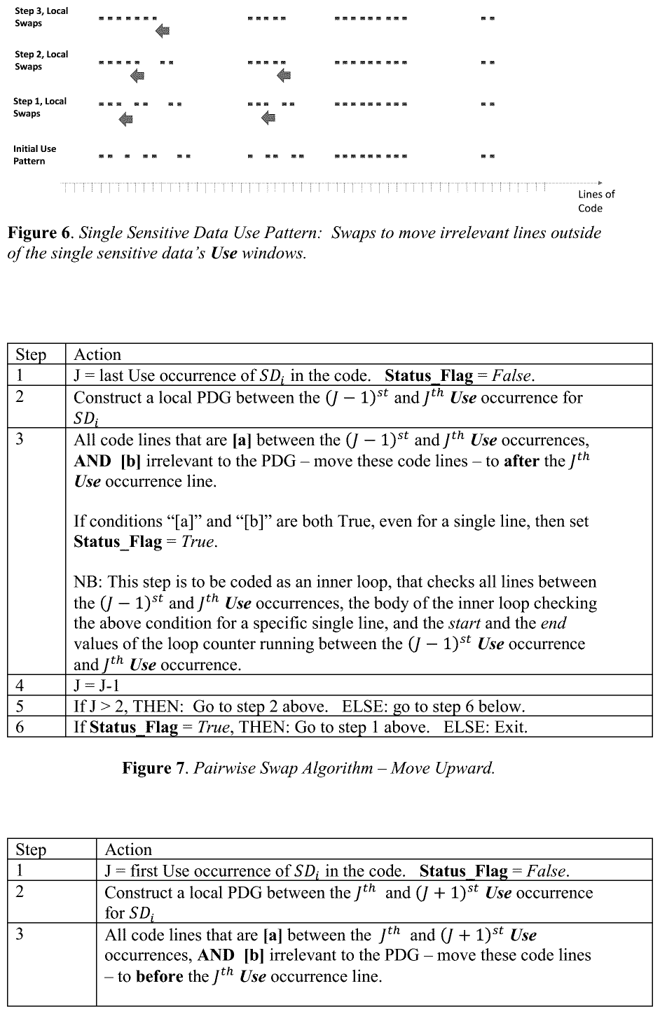

FIG. 6 shows a time (X-axis) chart of Use patterns for a specific sensitive data. If the program has 2 or more sensitive data, then one such chart can be drawn for each sensitive data. We will generalize to multiple sensitive data later, first we demonstrate the visual with a single sensitive data. The single sensitive data appears to be Used at four groups or four areas (aka. windows) of the source code.

The Initial Use Pattern is at the lowest. The 3 Swap Steps are shown progressively higher along the Y-axis. Each leftward blue arrow is a representation of a Swap. The Swap moves out irrelevant code from the Use windows to outside of the Use windows. The process to determine which code lines are relevant to a specific sensitive data is PDG analysis based, and is discussed in Section 6.1, 6.2.

FIG. 6: Deleted. See Drawings file for FIG. 6.

In the most ideal situation, all the dots relating to a specific sensitive data will be a continuous stream of lines, starting at some line L_{begin} and ending in L_{end}—where the lines between L_{begin} and L_{end} only relate to processing of the specific sensitive data and no unrelated activities.

This is of course the ideal situation. The programmer may not write code in this format. The programmer may do a variety of unrelated tasks between L_{begin} and L_{end}—which may be perfectly legitimate software development activities, but which are harmful from a Data in Use Risk exposure perspective.

The pairwise swap approach presented in this Section removes unrelated (to the sensitive data) code from inside of the [L_{begin}:L_{end}] range and pushes those code lines to outside of the [L_{begin}:L_{end}]

### 3.2 Removal of Unrelated Code Lines to Outside of Range

For a sensitive data SDᵢ, let us consider two adjacent successive Use lines—the j^{th} Use and the (j+1)^{st} Use. A Program Dependency Graph (PDG) is constructed³ rooted at the j^{th} Use line, and terminated at the (j+1)^{st} Use line. This is a local PDG, and not a global PDG. It only focusses the lines of code (specific to the sensitive data) between the j^{th} and the (j+1)^{st} Use of SDᵢ. ³ A PDG combines Data Flow Graph (DFG) and Control Flow Graph (CFG) [12]. We assume a reader familiarity of how to construct a DFG, and a CFG, and then how to combine them into a PDG.

If a particular line (l) of code, between the j^{th} and the (j+1)^{st} Use of SDᵢ, is not mappable to the local PDG, it would demonstrate that this particular line (I) is not relevant to the sensitive data SDᵢ and hence should be swapped out of the code window between the j^{th} and the (j+1)^{st} Use of SDᵢ. This process is repeated until all such lines (l) that have no PDG-marked relevance to SDᵢ, are removed out of the said window, and the window only consists of code lines that are directly relevant to SDᵢ.

### 3.3 Pairwise Swap—Moving Upward

Pairwise swap is a double nested algorithm, with a Status Flag (Boolean) set to False at the beginning of a full iteration. The Status Flag is turned to True, if a swap is successful, indicting that there was at least one line of code which was irrelevant to the sensitive data (per the PDG) and this line of code was swapped out of the window between the j^{th} and the (j+1)^{st} Use of SDᵢ. If the Status Flag is True, then a new iteration is commenced, to as to accommodate the potential transitive relationship effect between one swap that may invite a follow up swap.

The double nested algorithm starts from the last Use line (specific to the sensitive data) of the code, and then works progressively towards the front of the code. For example, if the code has 100 Use occurrences of SDᵢ then the algorithm would start from the 100^{th} occurrence and swap towards the 99^{th} occurrence, then from the 99^{th} occurrence to the 98^{th} occurrence and continuing until the (2^{nd} to the 1^{st}) occurrence pairs.

If during this full (i.e., complete) pass—from the 100^{th} towards the 99^{th} occurrence—even a single swap is successful, then the algorithm initiates another full pass from the 100^{th} towards the 99^{th} occurrence. The algorithm stops only when a full pass across the entire code lines results in no swap. FIG. 7 shows this algorithm, specific to SDᵢ.

FIG. 7: Deleted. See Drawings file for FIG. 7.

### 3.4 Pairwise Swap—Moving Downward

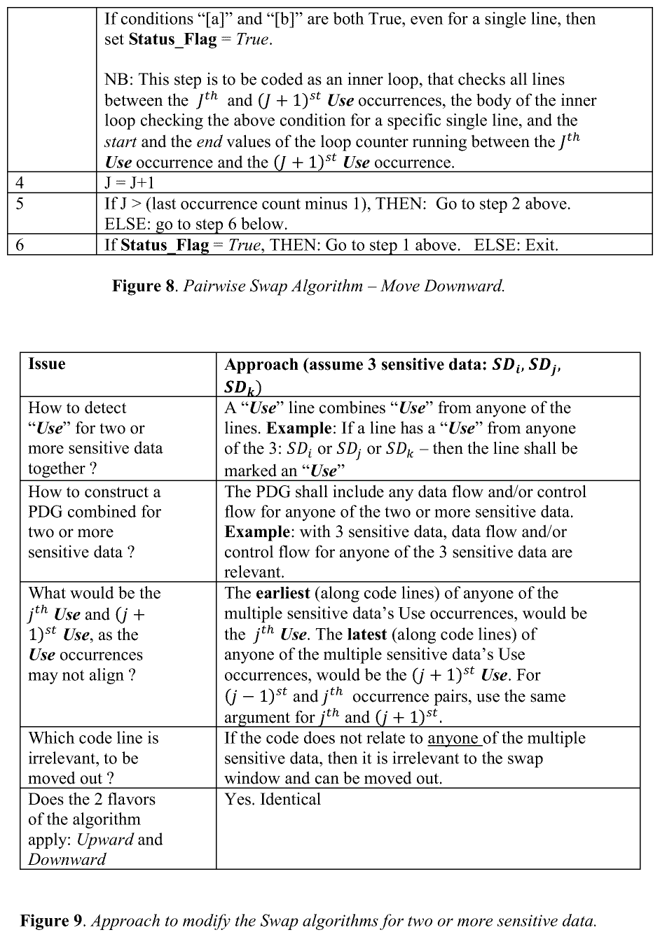

This algorithm is an exact dual of the above. It starts from the 1^{st} Use being moved to the 2^{nd} Use, then 2^{nd} to the 3^{rd}, and 3^{rd} to the 4^{th}, . . . till the (max−1) to the max, then start back at 1^{st} to the 2^{nd} and keep doing until a full iteration is completed without any further swap possible. This is shown in FIG. 8.

FIG. 8: Deleted. See Drawings file for FIG. 8.

### 3.5 Two or More Sensitive Data: Swap Algorithms

FIGS. 7 and 8 above is for a single sensitive data. While, a commercial code may not be expected to have 1000's of independent sensitive data, a few sensitive data is quite common. A question arises, how to implement pairwise swap of code lines when two or more sensitive data are involved. A diagram like FIG. 7 or 8 will arise for each sensitive data. If the diagram for one sensitive data SDᵢ leads to certain lines being moved downward, but, if the same lines relate to another sensitive data SDⱼ being moved upward—what should be the combined resolution?

We propose the following combining mechanism when two or more sensitive data are involved. See FIG. 9.

FIG. 9: Deleted. See Drawings file for FIG. 9.

### 4. Data in Use Pattern Clustering Algorithms

This Section presents a number of heuristics for clustering the Use patterns of two or more sensitive data. Section 3 presented the (pairwise) Swap based local clustering algorithms, but for a single sensitive data. It is also generalized for multiple sensitive data. However, they are all local clustering algorithms. They lack the global view. They operate on a bottom-up basis, not top-down basis.

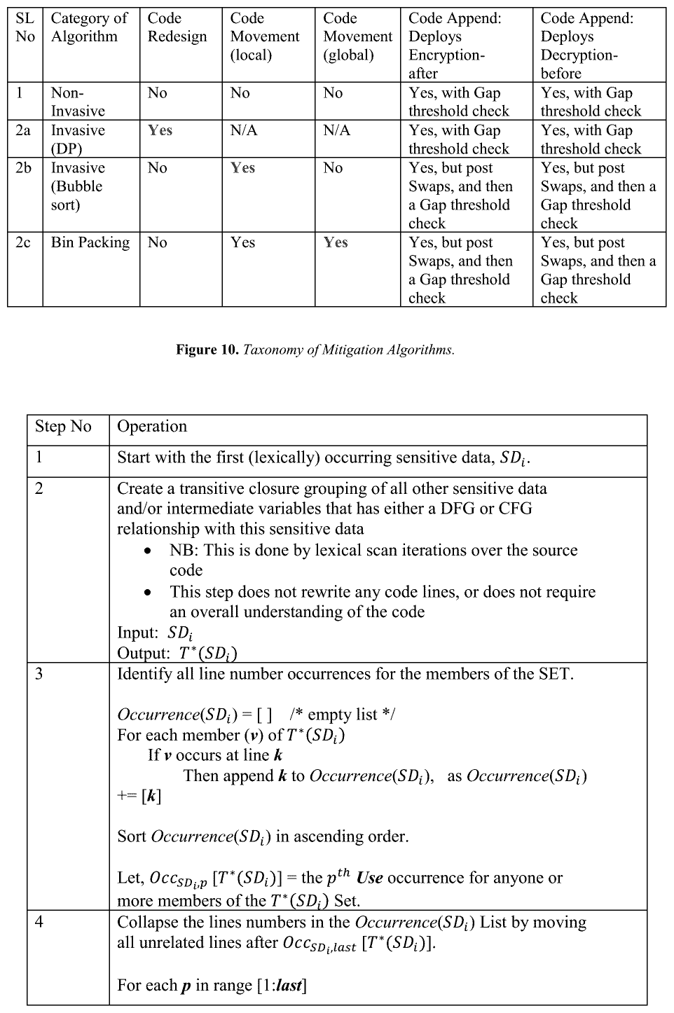

This Section presents top down clustering algorithms with two or more sensitive data values. FIG. 10 below presents a taxonomy of all Mitigation algorithms. Section 3 presented SL No 2b category of algorithm, and this Section presents SL No 2c category of algorithm.

FIG. 10: Deleted. See Drawings file for FIG. 10.

### 4.1 Problem Formulation

### Input:

L=total number of lines of code
N=number of sensitive data variables, Vⱼ, j: 0 . . . (N−1)
P_{j,k}=1, if Vⱼ has a Use on code line k, else P_{j,k}=0

### Output:

Produce N clusters, one for each sensitive data,
Q_{j,k}=1, if Vⱼ has a Use on code line k, else Q_{j,k}=0
   |Q_{j,*}|=|P_{j,*}|, indicating that the [output] Q-series for each sensitive data has the same number of Use lines as the [input] P-series, for the respective sensitive data.

### Optimization Objectives:

Minimize Exposure for each Q_{j,*} cluster
   Which means: Pairwise Use gap for all Q_{j,m}:Q_{j,m+1} is minimized
Minimize Cost for each Q_{j,*} cluster
   Which means: Cost incurred for all Pairwise Use Q_{j,m}:Q_{j,m+1} is minimized

### 4.2 Front Pass Clustering Algorithm

The Front Pass algorithm starts from the very first line of the code, and detects the earliest occurrence of anyone of the sensitive data SDᵢ. The objective of the algorithm is to identify all lines of occurrence of SDᵢ across the code. In a practical code, there may be intermediate variables which relate to SDᵢ, and those intermediate variables may in turn relate to some other intermediate variables (or, may even relate to other sensitive data SDⱼ, SDₖ, SDₘ and so on).

In a flow graph (data, and/or control) sense this is transitive closure formation. Let T*(SDᵢ) be the Set of all variables (sensitive or other) that has a control flow and/or data flow relationship to SDᵢ. The algorithm computes T*(SDᵢ) and then lexically detects all Use occurrences of any member of the T*(SDᵢ) Set across the code lines. The output of this lexical scan is a List, whose p^{th} element is denoted by Occ_{SD}_{_{i,}}ₚ[T*(SDᵢ)]=the p^{th} Use occurrence for anyone or more members of the T*(SDᵢ) Set.

Note that, the T*(SDᵢ) computation does not require any PDG formation. It is an invasive algorithm, to the extent that the algorithm swaps code lines in and out of their current places. But, the algorithm does not entail to a total redesign of the code. It moves existing code lines around, but does not redesign the code.

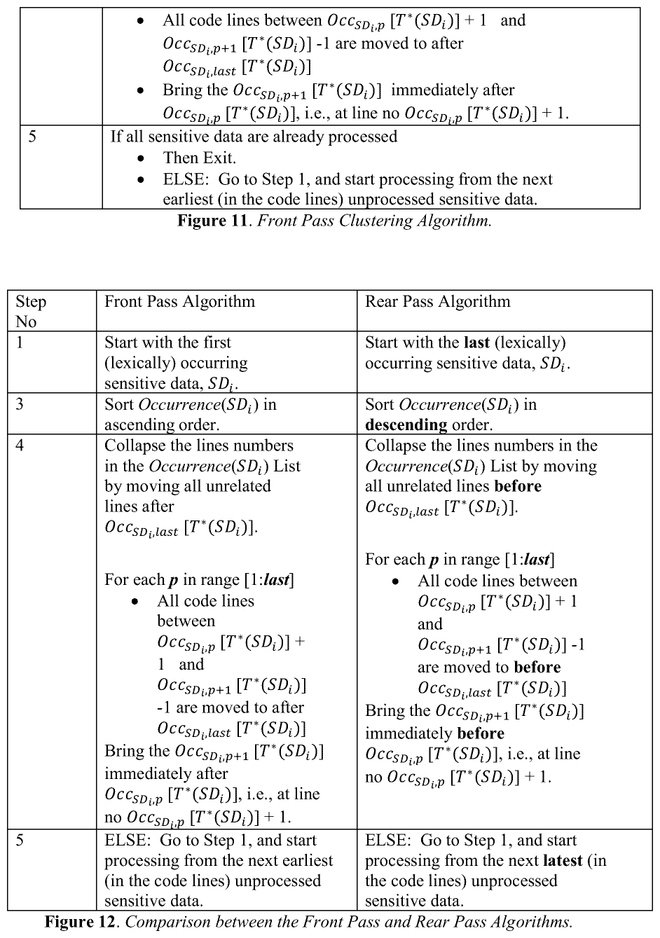

Finally, the p^{th} and (p+1)^{st} Use occurrences in the Lexical scan List are collapsed together to become at successive line, instead of being far apart. Thus, Occ_{SD}_{_{i,}}ₚ₊₁[T*(SDᵢ)] becomes Occ_{SD}_{_{i,}}ₚ[T*(SDᵢ)]+1. FIG. 11 shows this algorithm.

FIG. 11: Deleted. See Drawings file for FIG. 11.

### 4.3 Rear Pass Clustering Algorithm

The Rear Pass algorithm is dual to the Front Pass algorithm. It starts from the tail end, the last line of the source code, and scans forward. The differences between these two algorithms are shown in the below FIG. 12, which is to be read in the context of the full Front Pass algorithm stated above.

FIG. 12: Deleted. See Drawings file for FIG. 12.

### 5. Non Invasive Mitigation Algorithms

Section 2.5 listed a number of Mitigation algorithms, of which the Front and Tail Trim algorithms and Code Partition in entirety algorithms are presented in this Section.

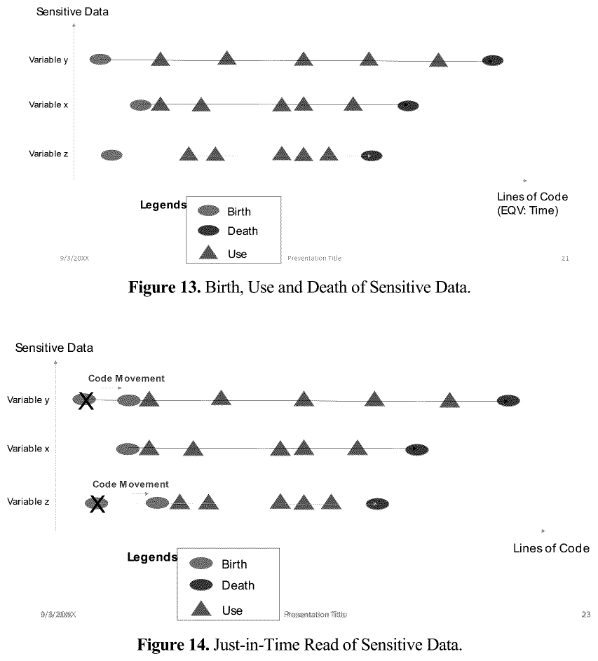

Notion of Birth, Use and Death of sensitive data is presented. FIG. 13 shows a timeline diagram of the activities specific to a sensitive data. The X-axis is time, representing successive lines of code⁴. As the software executes the timeline (and, corresponding active line of code) moves from the left to the right. The Y-axis is different sensitive data elements. There is no differential (higher or lower) notion along the Y-axis. Different points along the Y-axis are unordered points, one for each sensitive data. ⁴Effect of loops and other forms of go-back within the code are blurred for simplicity. In an actual code, if there is go-back in lines of code (LoC), but progressing per time, then the LoC should be notionally unfolded. Example: a loop of N iterations with a code body B, should be notionally unfolded as N copies of B sequentially placed.

FIG. 13: Deleted. See Drawings file for FIG. 13.

The life-span of a sensitive data is the time lag between its Birth and Death. During this life-span the sensitive data is in the memory, which can be compromised to gain unauthorized access. Likewise, if the code does an abort then the Heap contents may be dumped into a HD, which is another source for unauthorized access to the sensitive data.

A reduction of the life-span proportionately reduces the amount of time the sensitive data stays in memory, and hence proportionately reduces the attackers opportunity to gain access to the sensitive data while it is in use. This section presents such methods:
Not reading the sensitive data too early in the code and keeping it active in the Heap without using it. The sensitive data should be read just before its first use.
Not preserving data in Heap after its last Use.
Secure wipe and release of the sensitive data after its last Use.
Partitioning the code to separate out code, one for each disjoint set of sensitive data.

### 5.1 Just-in-Time Read

FIG. 14: Deleted. See Drawings file for FIG. 14.

For every sensitive data, its Birth timeline in the Lines of Code is detected by lexical analysis. If a Birth is too far ahead in the code timeline, compared to its very first Use, then the Birth is postponed in the code timeline to bring it to immediately prior to its first Use.

This is shown in FIG. 14. For Variables Y and Z, their respective Births are postponed to immediately prior to their respective first Use. For Variable X, this is not necessary, as the source code is correctly written, there is no significant timeline gap between the Birth and first Use. A pseudo code for Just-in-Time Read is shown below in Table 5.

Table 5: Deleted. See Drawings file for Table 5.

Depending on how the “Read” is constructed, e.g., from a Database or from a Message Inbox, or a command line input, or a file read, a syntax validation may be necessary. This is a one time manual operation, post which the updated code requires no further update or maintenance.

### 5.2 Expedited Death

For every sensitive data, its Death is spotted by the Lexical analyzer. If no specific Death of a sensitive variable is inserted in a code, then the Death is aligned to the last line of the code. Depending on the programming language syntax, the Death may be release of a pointer, or setting a pointer to Null. If a Death is too far delayed in the code timeline, compared to its very last Use, then the Death is preponed in the code timeline to bring it to a point immediately after its first Use.

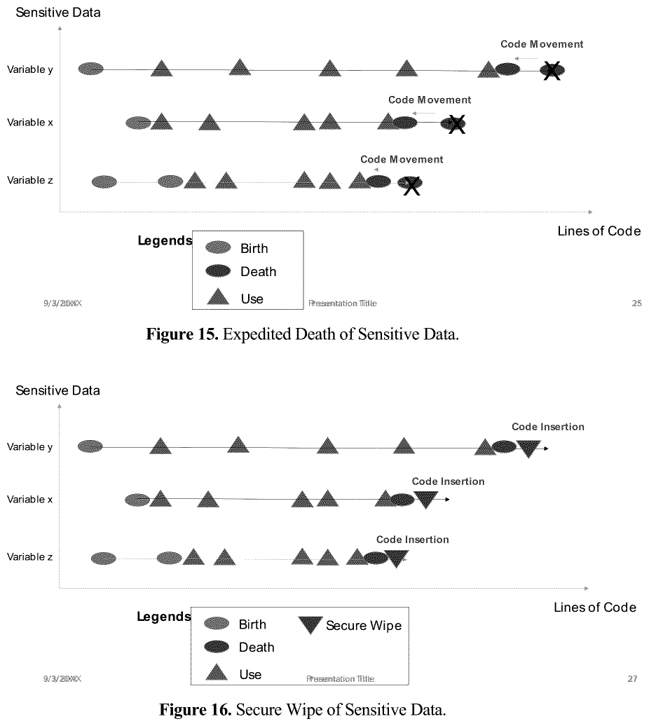

FIG. 15: Deleted. See Drawings file for FIG. 15.

This is shown in FIG. 15. For Variables X, Y and Z, their respective Deaths are preponed to immediately after their respective last Use. A pseudo code for Expedited Death is shown below. Depending on how the “Release Pointer” is constructed, e.g., return of a pointer or setting a pointer to Null, or simply not doing anything regarding the specific sensitive data element, a syntax validation may be necessary. This is a one time manual operation, post which the updated code requires no further update or maintenance. Table 6 shows the pseudo code for Expedited Death.

Table 6: Deleted. See Drawings file for Table 6.

### 5.3 Secure Wipe

FIG. 16: Deleted. See Drawings file for FIG. 16.

For every sensitive data, it must be wiped securely, absent which there is always a possibility that the sensitive data may reside in the memory somewhere and reach the wrong hands eventually. Secure Wipe is an industry standard, for disks, where 3 or more times overwrite onto the sectors are performed, see DoD 5220.22-M [9] for defense sector implementation of the same, and NIST 800-88 for the same for commercial sectors. However, when the data is on a Cloud platform, a question arises as how to secure wipe the data when the physical disk sectors are not within Client control.

This invention presents a secure overwrite, instead of secure wipe, where the overwritten content is a random bit stream (=white noise). As an example, if the Expedited Death operation is a pointer release or pointer being set to Null, then the Secure Wipe would set the pointer to a random bit stream, so that whichever physical location the system underlie may have been writing the data to, the very same physical location would now get overwritten with a random bit stream.

Note that without the Secure Wipe step, a mere release of the Pointer does not erase the sensitive data—the sensitive data does stay in the memory, it is only the Pointer that looses track of where the sensitive data might be. In such a case, an attacker with a full dump of the memory (or, likewise the Log file post a core dump) may be able to access the sensitive data.

This invention presents an explicit overwrite, with random bit-stream, so that the sensitive data is permanently wiped. FIG. 16 shows the Secure Wipe, with an explicit code insertion. In typical Client deployments, Secure Wipe would be a library provided by the inventor, embodied specific to the programming language of the code, and ability to link at run time and make a single procedure call. A pseudo code for Secure Wipe is shown below (Table 7).

Table 7: Deleted. See Drawings file for Table 7.

Depending on how the “Secure Wipe” is constructed, e.g., calling a library, or writing code within the Application itself, a syntax validation may be necessary. This is a one time manual operation, post which the updated code requires no further update or maintenance.

### 5.4 Code Partitioning for Disjoint Sets of Sensitive Data

The above approaches focus on single sensitive data, to reduce its Attack Surface. In most codes sensitive data do not work in isolation, instead 2 or more sensitive data may interact with each other, either in computation or in business logic decisions. Computation example: two sensitive data being added to produce a third sensitive data. Business logic example: if a certain sensitive data is below a threshold send an alert message.

Opportunity for Code Partitioning: For two or more Sensitive Data Elements (which interact in computation and business logic), how to restructure their relative “Use” lines of code—so that (a) they can be brought closer in timeline of execution, and (b) sensitive data that are not relevant to one section of the code can altogether be removed from the Heap, i.e., partitioning the code.

While manual (re-programming, using human intuition) can always be done, this invention presents an automated way of doing so. See Table 8 below.

Table 8: Deleted. See Drawings file for Table 8.

The above algorithm is an automated way of reshuffling the code, so as to cluster the code by sensitive data elements' usage, and minimize the life-span of sensitive data thereby reducing their respective Attack Surfaces.

### 5.5 Best Practices for Secure Code Development (Context: Data in Use Risk Reduction)

Section 2.5 presented a taxonomy of Mitigation algorithms. Algorithms marked “1”, “2” and “6” are presented in this invention, while the other 3 Algorithms (3, 4 and 5) are parked for a follow up research report. A summary of these algorithms can be stated with a dual⁵ perspective, which then becomes a programmer's guideline as how to write a better quality code (in Data Security Risk reduction context). These Best Practices are intuitive guidelines. Like any Best Practice, they are “ball park, sweeping statements”, may not be precise or mathematical. They are engineering thumb rules, reported as below. Note that only those sensitive variable explicitly cited by the Application User are taken into consideration. The program may have other sensitive variables, but their Data in Use exposure is not relevant to the context. ⁵Dual means reversing the thought process, [original thought process of] instead of looking to Mitigate the Risk, [dual thought process being] advise the programmer to write code in a way that the Mitigation would be already adopted in the source code.

Singleton sensitive variable, SDᵢ (without any dependency to other sensitive
variables):

| | |
|---|---|
| 1. | Develop a Program Dependency Graph (PDGᵢ). |
| 2. | PDGᵢ may include other intermediate variables that receive the sensitive data, |
| | passes onto the sensitive data to other variables, be part of business logic |
| | operations - but, by definition, PDGᵢ shall not include any sensitive data SDⱼ that |
| | may have been specified by the Application User. |
| 3. | From the Start node of the PDGᵢ, write code to implement each node of the PDG. |
| | Follow the precedence graph arrows, so a successor node becomes ready to be |
| | coded only when its predecessor nodes are fully coded. |
| 4. | Do not bring any extraneous code outside of the scope of this PDGᵢ |
| 5. | Implement each node of the PDGᵢ - until all nodes are exhausted, and code for all |
| | nodes are completed. |
| 6. | The code lines developed for PDGᵢ is a cluster. It should be treated as a single |
| | entry and single exit segment of code (of M lines). |
| 7. | Suppose the overall source code is of N lines, with N > > M. |
| 8. | Then these M lines can be placed anywhere along the N lines, but these M lines |
| | must be contiguous, without any extraneous (unrelated to PDGᵢ) code interjected |
| | in between. |

Multiple related sensitive variables: SDᵢ, SDⱼ, SDₖ (without any dependency
to any other [outside of i, j, k] sensitive variables):

| | |
|---|---|
| 1. | Construct a PDG_{{cluster}}, but only including the SDᵢ, SDⱼ, SDₖ and no other |
| | sensitive data. This PDG_{{cluster}} may include other intermediate variables, but |
| | only if those intermediate variables have a data or control flow dependency to |
| | anyone or more of SDᵢ, SDⱼ, SDₖ - not otherwise. |
| 2. | Essentially, a cluster is being formed, consisting of SDᵢ, SDⱼ, SDₖ and every |
| | intermediate variable that relate to one or more of SDᵢ, SDⱼ, SDₖ - but none other. |
| 3. | Repeat steps no 3-8, per the case above, by treating the PDG_{{cluster}} as if it is a |
| | singleton node like PDGᵢ |

The notion of “Atomicity” is well known in RW conflict resolution or NMI (non-maskable interrupt) processing. A similar concept appears to be effective while writing secure code (in the context of Data in Use security attack surface reduction). What is really being done is—[1] identify and track the sensitive data variables, [2] capture the data flow and control flow to build the PDG, [3] if two or more sensitive data are related in the PDG then cluster them and treat the entire cluster as a single PDG, and [4] codify the PDG nodes per the dependency arrows, [5] ensure no extraneous (to the PDG) code is interjected, so the entire PDG cluster is coded a single atomic segment. It is expected that this atomic segment would be single entry and single exit.

It is possible to extend this analysis to denotational semantics or mathematical programming techniques, which are outside the scope of this invention.

### 6 Invasive Mitigation Algorithm: PDG Based Problem Formulation

The Invasive Mitigating algorithms revert the source code to the design white board. It starts with identifying the list of sensitive variables, and then grouping them into disjoint sets. Data flow graph (DFG) and Control flow graph (CFG) are fundamental programmatic context, and the Program Dependency Graph (PDG) which combines DFG and CFG is being utilized in the current context.

Singleton Sensitive Data: If a sensitive variable SDᵢ is not related (by any arithmetic or logical [AOL] operations) to any other sensitive data, then SDᵢ is a singleton and its PDG can be constructed by including only the arithmetic and logical operation SDᵢ participates. The PDG construction must accommodate transitive relations, so if SDᵢ has an AOL relationship with another intermediate variable (not necessarily sensitive), Interim_Var1, then all AOL operations of Interim_Var1 must also be included in the same PDG with the PDG of SDᵢ. Likewise, if Interim_Var1 in turn relates to Interim_Var2, then the PDG for Interim_Var2 must also be included in the foregoing PDG construction. This process of transitive inclusion making shall continue until no new interim data is detected to have any AOL relationship to anyone or more of the data items in the PDG, at which time the PDG construction shall be deemed complete.

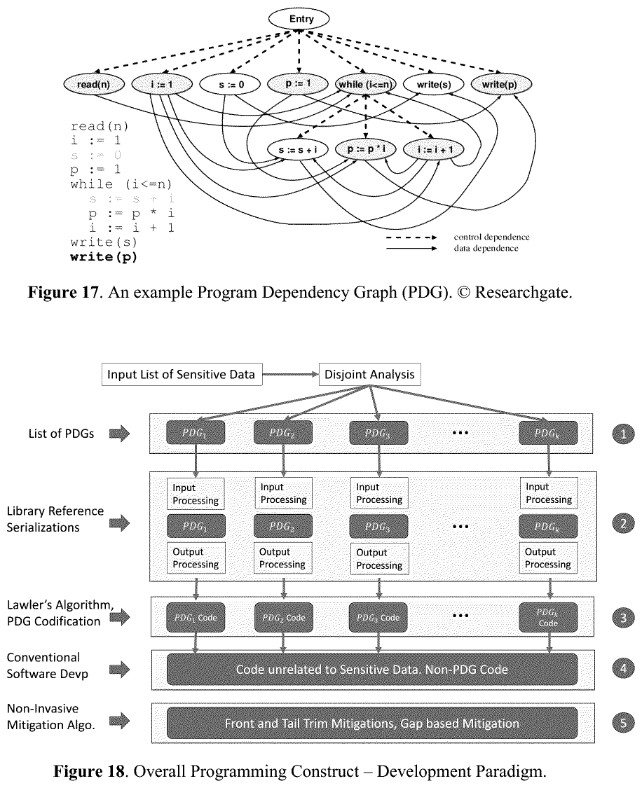

FIG. 17 below shows a sample PDG, taken from [13], Copyright @ Researchgate.

FIG. 17: Deleted. See Drawings file for FIG. 17.

Multiple Related Sensitive Data: If two or more sensitive data, e.g., SDᵢ, SDⱼ, SDₖ and SDₘ are related by AOL operations, then their PDGs must be constructed together. All intermediate variables that has any AOL relationship to anyone of more of the [SDᵢ, SDⱼ, SDₖ and SDₘ] set of sensitive data elements must also be progressively grouped together in the same PDG. The stopping criteria is the same as with the singleton sensitive data case—i.e., the process of transitive inclusion making shall continue until no new interim data is detected to have any AOL relationship to anyone or more of the data items in the PDG, at which time the PDG construction shall be deemed complete.

Once the PDG is constructed, the Mitigation algorithm codifies the PDG nodes starting from the “START” (node marked “Entry” in FIG. 17) node and following the dependency edges of the PDG. Creating code for the nodes of the PDG as shown in FIG. 17 is trivial.

Practical Considerations (Scope for Optimization): An example best illustrates the process. Suppose in FIG. 17 the variable “n” is sensitive, and so is the variable “s”. Creating code lines for PDG nodes may appear to be trivial, except the implementation of “read” (as with read(n)) and “write” (as with write(s)) might be more complex than they appear. If the read(n) and write(s) are single lines of code, then there is no Data in Use Risk reduction opportunity to encrypt (immediately after) and decrypt (immediately before). However, in a more complex environment, the read (n) may be a Database read, that requires opening a DB channel, creating a socket, getting an entire Record, and then applying a Schema lookup to pick a particular field. Likewise, the write(s) may be a write into a multiple sheet Spreadsheet file, to a specific sheet, and search upon which (row, column) to write based upon a business logic test. All of these steps will not be a single line of code, therefore a question arises if the line where n is read versus where n is used-might there be an opportunity⁶ to encrypt after and decrypt before to reduce the Data in Use Risk. ⁶In the languages of Optimization, the same matter would be phrased as: the sizes of each PDG node may not be the same. Some nodes may be more complex than the others. The PDG nodes would have weights (=execution time in lines of code), as source for optimization.

Therefore, (a) while in principle the PDG being solely involved with sensitive data and intermediate variables, and none other, and furthermore (b) while it may appear that the process of coding the PDG nodes is non-ambiguous—in reality, certain PDG nodes may reference to abstract and high level tasks whose implementation may require a large number of lines of code. In such situations, it is not straight forward to determine if there is, or isn't opportunities for further Data in Use Risk reduction by deploying the encryption after and decryption before methods.

For these reasons, we formulate the below Job Shop scheduling problem for codifying the PDG implementation, first as a general purpose Job shop scheduling problem with arbitrary number of machines, and then constraining it to a Job shop scheduling problem with single machine.

### 6.1 Mapping to Job Shop Scheduling Problem

Below is one (among many) formulation of the optimization problem.

Given a Set (N) of Jobs, with defined precedence graph amongst them
A Job is a certain chunk of Arithmetic and Logical Operation
involving the sensitive data (SDᵢ).
1 or more Nodes as Start. A Start Node does not have any prior
dependencies.
1 or more Nodes as End. An End Node does not have any
antecedent.
A number of (M) Machines.
For execution simplicity, assume 1 CPU. But, most platform may
have 4 or 8 CPUs, which is a generalization made later (see Sections
6.3, 6.4).
How to order execution of these Jobs, such that:
Time gap between the a previous Node's last use of SDᵢ and a
successor Node's earliest use of the same SDᵢ is less than the (E + D)
threshold.
Where, E (and, D) is the execution time of encryption (and,
decryption) library in FLOPs (or, equivalently in Lines of Code
scaled abstraction).

This problem appears similar to the Job shop scheduling problem, extensively studied in Computer Science and Operations Research.

Job shop scheduling problem: A set of jobs or tasks (each job or task being represented as a node), interconnected by a precedence graph, each node having zero or more predecessor nodes, and each node having zero or more successor nodes, and each node with an weight indicative of an execution time—how these jobs can be scheduled to be executed by a set of independent machines to optimize the total execution time (aka. Makespan). With minimize Makespan objective, below are a few known results.
Unitary job weights: The problem is trivially solvable if all Jobs (aka. Nodes) are of the same weight.
Only one machine: The problem is also polynomial solvable if the Jobs are of arbitrary weight, but there is only one machine.
Arbitrary job weights, multiple machines: But, the problem is NP Hard, if there are multiple machines and each Job can be of arbitrary size.

Next, we generalize from the minimize Makespan objective. Below are a few well known variants of the Optimization objective for a single machine execution.
Optimization Objective 1: Maximize Throughput
Optimization Objective 2: Minimize the sum of completion times (NB: sum of completion times is not the same as Makespan. Makespan is the total completion time.)
Optimization Objective 3: Maximize the profit of earliness
Optimization Objective 4: Minimize the cost of lateness.

Of these, the “minimizing the cost of lateness” (Optimization Objective 4) is the closest to our context, with the below objective.

Optimization Objective: Minimize the Cost of Lateness, if Lateness is defined as
a Step function using (E + D) as a Threshold

| | |
|---|---|
| Lateness | = 0, if < (E + D). [Option 1] |
| | = E + D, otherwise [Option 2] |

Option 1 is when encrypting after the last Use and decrypting before the next
Use, would not reduce any Data in Use Risk exposure.
Option 2 is when it would. Encrypt after the Use, and Decrypt before the next
Use

### 6.2 Mapping to Job Shop Scheduling with Single Machine Problem

Section 6.2 mapped the current problem to Job shop scheduling and narrowed it to a single machine scheduling problem, with the Optimization being reducing the cost of Lateness, where Lateness is defined as a step function.

In this subsection, we review known results in this specific narrowed context. We review 3 special cases—2 of which do not fit to our problem context, and the 3^{rd} which may fit and may even be an exact fit. This exact fit problem has been known to be solved Polynomial by Lawler's algorithms which is reviewed.
Special Case 1: Jobs have no precedence relationship. Optimization objective is minimize the maximum Lateness. This special case does not fit to our context, as our problem is mired with a Precedence Graph.
Special Case 2: Similar to special case 1, but the Jobs have a varying release time. This is overly restrictive, as our problem does not need general purpose Release time for each Job. In our case, the Release time is specific and determined the latest completion time of all the predecessor Jobs.
Special Case 3: Jobs do belong to an arbitrary Precedence Graph, and Jobs do support arbitrary Cost function. This case fits to our problem. It supports the Precedence Graphs. It also supports the Lateness cost function.

Lawler's algorithm is repeated below to solve our PDG scheduling problem. However, this algorithm fails in its optimality claim, when more than one machine (e.g., Quad-CPU) is involved. The next subsection 6.3 provides a solution for such situations.

Pre-Processing: Compute the Due Date of each PDG node (nₖ) as the Start
time of the node + (E + D).
“E + D” is the Gap threshold, beyond which implementing an
Encryption after and Decryption before makes sense and would
reduce Data in Use Risk exposure.
Start time of the node (nₖ) is computed as the Critical Path on the
PDG graph, and summation of all nodes whose completion is a
prerequisite to commence the execution of the node (nₖ).
Let d(nₖ) denote the deadline for the node (nₖ).
Initialization: Iterative algorithm, with iteration index = 1 to start with. Set of
Jobs without any successor node = [Current Job Set] all PDG nodes which have
no outgoing edge in the Precedence Graph. Target time [Current Target Time]
to complete = sum of all PDG node's execution time.
Iteration:

| | |
|---|---|
| 1. | For all PDG nodes (nⱼ) within the Current Job Set, select the PDG |
| | node with the largest d(nₖ). |
| 2. | Schedule (nⱼ) to complete at Current Target Time, time slot. |
| 3. | Increase iteration index by 1 |
| 4. | Update Current Job Set by marking (nⱼ) as a completed PDG node |
| | and including its immediate predecessor nodes into the Current Job |
| | Set |
| 5. | Update Current Target Time, (as sum of all remaining PDG node's |
| | execution times) after deleting node (nⱼ) from the remaining |
| | unfinished PDG node's execution time, as (nⱼ) has now been |
| | completed. |
| 6. | Go to step 1. |

Practical consideration: The time may be approximated by counting the Lines of Code, as a rough measure of the FLOPs scaled to a “per line” basis. Therefore, it may not be necessary to compute the PDG node's execution times in FLOPs, instead a count of the number of lines of code it would take to implement the PDG node's function may suffice.

### 6.3 Single Machine Execution: Deviation and Reinforcement

The entire optimality claim in Section 6.2 relies on a single machine assumption, which may not be a valid assumption as modern processors have more than one CPUs. To make matters more complex, some of the library calls that may be involved in PDG node execution may reference out to other Servers, with a completely different execution platform. A database related library call is such an example. The library references to execution of a piece of code, may be short or may even be medium sized, but is on a different platform—namely the Database Server. The Database Server is a separate machine, unrelated to the host Server where the main program is running.

The DB library call may be part of both an input parameter preparation, or an output value write operation. Other examples of 3^{rd} party machines would include an Web Service reference that is manifested on a remote Web Server, or a transactional batch processing system that interacts with another Server altogether, and so on.

The question therefore becomes—is the optimality claim unreal for practical embodiments. This invention proposes a serialization (of library references) programming concept that can alleviate this problem and reinforce the single machine assumption and hence reinstate the optimality assertion.

### 6.4 Library Reference Serialization—Reinforce Single Machine Assumption

To reinforce the single machine assumption, we evaluate why and where the Library references occur.
If the Library references are unrelated to the sensitive data items, then the solution is simple: Remove the Library reference to outside of the PDG. The Library reference has no relevance to the sensitive data, and it is out of scope (as far as the PDG references are contexed).
If the Library reference is indeed related to the sensitive data, then we question what the Library reference is accomplishing. We follow the IPO (Input, Processing, Output) model of computing. Thus, the Library reference can be doing one of the below 3 type of activities:
   Use Case 1: Complex processing involving one or more of the sensitive data element(s).
   Use Case 2: Processing of an input, that requires certain remote server participation. The input, upon being ready, shall be used to conjoin with the sensitive data element(s).
   Use Case 3: Processing of an output, which received its value from the sensitive data. The output, to become readied, requires certain processing at an external machine, which is what the Library reference is accomplishing.
We propose a programmatic construct where:
   Use Case 1 is flattened out within the PDG itself, without having to make a Library call for an external machine execution.
   Use Case 2 is implemented before the PDG execution commences, as an input preparation ahead of time.
   Use Case 3 is implemented by buffering of the output and then postponing the output processing after the PDG is completed.

Methods to support Use Cases 2 and 3 are what we term as Library Reference Serialization. As an example, with the PDG presented in FIG. 17, if the two variables n and s are sensitive, and the two references [read (n)] and [write(s)] are complex enough to require remote machine execution, then
read (n) shall be implemented before the PDG execution starts. If “read (n)” requires opening a DB socket, establishing a DB channel, parsing a DB schema, spotting a specific record and then reading the desired value—these steps normally being executed on the DB server, will still be executed on the DB server, but the entire Library reference shall be made before the PDG execution commenced. As a result, when the [read (n)] line within the PDG is going to be executed, the outcome of the read (n) operation is already available (presumably in some intermediate variable) locally at the machine where the PDG is being executed.
write(s) shall be implemented after the PDG execution ends. If the write(s) required complex, multi-step DB server processing, then all those steps can and will be executed on the DB server, but not inside the PDG execution. An intermediate variable will hold the value, generated from within the PDG. Only after the PDG execution is completed, that intermediate variable shall be used to make the Library reference call to execute at the remote machine, to accomplish what was previously being intended to be accomplished from within the PDG.

The net effect of the Library Reference Serialization is that-within the PDG nodes execution timeline, the single machine assumption is reinforced. No outside machine Library reference back and forth are involved. Hence, the optimality using Lawler's algorithm is reestablished.

### 6.5 Overall Programming Construct/Software Development Steps

FIG. 18 shows the overall programming construct, or the list of steps for the developer to develop code to maximize Data in Use Risk reduction. It is a 5-Step process, as indicated by the circled numbers (1), (2), . . . , (5) at the right side.

FIG. 18: Deleted. See Drawings file for FIG. 18.

The 5-step process is described below.
Preprocessing Step: Stakeholder input is taken to identify (lexically) the sensitive data names, and do a Disjoint analysis to create clusters of sensitive data items-one cluster for each disjoint set.
Step (1): Each disjoint set of sensitive data is analyzed to determine its business logic, and the Arithmetic and Logical Operations are captured into a respective Program Dependency Graph (PDG).
Step (2): Here all Library References inside the PDG is serialized. See Sections 6.2-6.4 for rationale and how to. As an output of Serialization, each PDG becomes-first an Input Processing, then the PDG execution, then an Output Processing.
Step (3): This is the optimality assertion (see Sections 6.2 and 6.3), where each PDG is codified under a single machine assumption. The PDG execution becomes a piece of code in this step. While, the Input Processing and Output Processing remain the same from previous step.
Step (4): In this step, all business logic unrelated to the sensitive data are implemented. This is business as usual software development, without any specific attention given to the data sensitivity. All data, unless marked sensitive, are presumed non-sensitive and hence in this step all business logic operations about such non-sensitive data are implemented.
Step (5): This step implements the non-invasive mitigations on the entire code. Front trim is implemented by spotting the very first occurrence of a sensitive data, and encrypting a dummy reference to the said data from line 1 till its very first occurrence (=“Use”). Likewise, the Tail Trim implements an encryption of the sensitive data after its last Use and never decrypts it, instead randomly overwrites to implement a secure wipe. And, Gap based single pass over the in-between code checks each Use and its lines' gap to the next Use, to determine if an “encrypt after” and “decrypt before” implementation would exceed the execution cost of (Encryption+Decryption). If yes, then it inserts a pair of “encrypt after” and “decrypt before” steps.

In practice, a developer environment may implement these steps, as/when a commercialization may occur along this line. A tool like Visual Studio may embody these development environment steps, to assist secure code development.

### 7. Intermediate Variables and Data in Use Risk Reduction

Intermediate variables that may be used by the programmer require special treatment when it comes to Data in Use protection. Ideally, the programmer should not use any intermediate variable at all, and all processing must be directly on the sensitive data variables. However, intermediate variables usage is a personal style for many programmers. Furthermore, in some specific cases, intermediate variables provide easier method to implement certain code logic steps, such as interchanging values between two variables. Therefore, one must be able to accommodate intermediate variables.

### 7.1 Best Practices and Operating Models for Intermediate Variables

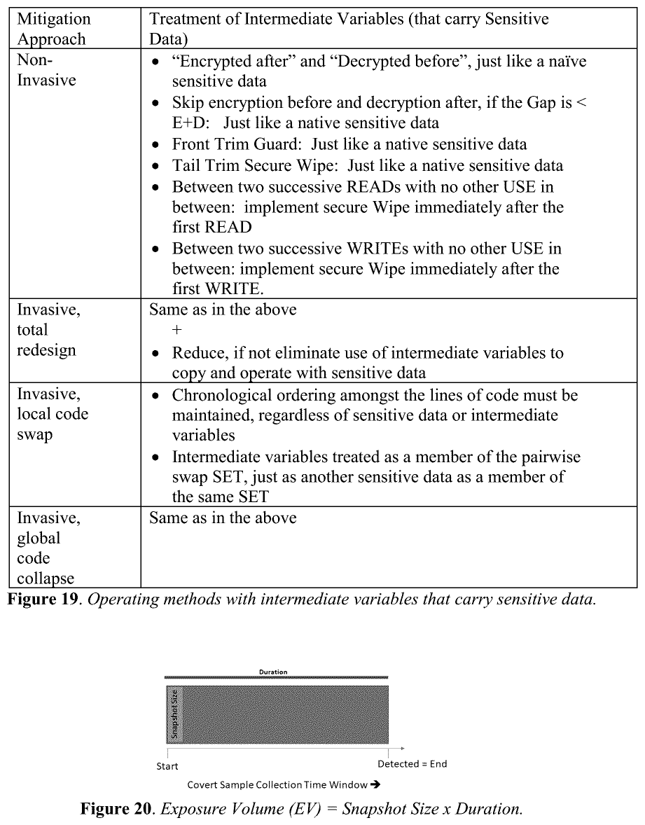

Below FIG. 19 highlights best practices and operating methods around intermediate variables that handle sensitive data. Note that other intermediate variables, which do not handle sensitive data, are out of scope and not relevant to our context.

FIG. 19: Deleted. See Drawings file for FIG. 19.

### 7.2 Use Cases and Rationale Underlie Intermediate Variables

Our scope is “sensitive data” as/when held by the intermediate variables. Therefore, “what it holds” is unquestionably sensitive data. We enumerate the “how”, “where”, “why”, “when activated”, “declared how” and “destroyed how” attributes of the intermediate variables below.
Usage—How: This can be of 3 Options. (a) Using dedicated lexical names: Example—Temp_Account_No, (b) Using lexically constructed name at run-time: Example—var{:_i}, which will become var_1, or var_2, or var_35 . . . at run time, depending on the value of I, and (c) Using pointer: Example—<ptr>, which will get a runtime linked address by the compiler and execution environment.
Usage—Where: This can be of 3 Options. (a) At near by lines of code, local region: Within a span of few lines, hold a temporary data, used in swaps of the data, as a receiver or sender of data from/to a TCP socket. (b) Across the code lines widely apart, to pass values, from one part of the code to another part of the code. (c) As a global variable, for data being accessed across the code lines.
Usage—Why: This can be of 3 Options. (a) Ease in data structure. Typical example, interchange pairwise values between two other variables. (b) As a programmatic construct to buffer construction, for sending and/or receiving data to/from a channel (DB channel, TCP socket), and (c) Programmer's mental model assistance. The programmer likes to ease the information space views, and used temporary data spaces to layout information with clarity.
Usage—When (activated at what times): This can be of 2 Options. (a) Static and predictable occurrence: Example 1—after line no 210 and before line no 212. Example 2—on line no 217, which is within a loop and the loop iterations 1:50 times. (b) Dynamic and Run-time value driven occurrence: Example: bold, italicized variables.

```
If the Account_Balance < min_threshold,
    Then:
    Read (client_phone_no)
    msg = lookup[canned_message, index]
    Send_SMS(client_phone_no, msg)
```

Usage—Declared How: This can be of 4 Options. (a) Static declaration: int Temp_Account_Balance=0. (b) Not declared, initiated at the first Use. (c) Run-time declared: declared by a lexical connstruct which gets its value at run-time. (d) Conditionally declared: Declared within a IF-condition structured.
Usage—Destroyed How: This can be of 3 types. (a) Release based Destroy: release (ptr). (b) Not destroyed lexically, just stopped using it, and at the end of the code the Garbage Collector does the Destroy. (c) Explicit value overwritten by random bytes.

### 7.3 Summary: Analysis Underlie Intermediate Variables

| | Data in Use Risk Mitigation Note |
|---|---|
| 1. Usage: How | |
| a. Using dedicated lexical | Can be lexically detected. Treat as any other sensitive data. |
| names | Identify by value association to other sensitive data. |
| b. Using lexically | Cannot be lexically detected. Must be tracked starting from |
| constructed name at run- | value association to other sensitive data |
| time | |
| c. Using pointer | Can be lexically detected. Treat as any other sensitive data |
| 2. Usage: Where | |
| a. At near by lines of | Front Trim and Tail Trim are the two most effective |
| code, local region | Mitigation methods, covering 9x % of the issues. Intermediate |
| | Uses have no significant impact. |
| b. Across the code lines | Front Trim and Tail Trim are not significant and may even |
| widely apart | be useless. Deploy encrypt-after and decrypt-before |
| | methods, as with any other sensitive data. |
| c. As a global variable | Same as #2b above |
| 3. Usage: Why | |
| a. Ease in data structure | Cannot be avoided, must have been put there for good reason. |
| | Treat as #2a, if used only once locally, or as #2b |
| b. Programmatic | Cannot be avoided, must use per language requirement. Treat |
| construct to buffer | as #2a, if used only once locally, or as #2b |
| construction, for sending | |
| and/or receiving data | |
| to/from a channel | |
| c. Programmer's mental | Consider redesign, to reduce potentially excessive usage of |
| model assistance | Intermediate Vars |
| 4. Usage: Activated at | |
| what times in the code | |
| a. Static and predictable | Handled just like a sensitive data, post lexical scan detection |
| occurrence | |
| b. Dynamic and Run-time | Similar to #4a above, except it is qualified by a pre-condition |
| value driven occurrence | |
| 5. Usage: Declared - | |
| how | |
| a. Static Declaration | Caught with a Front Trim, until 1^{st} Use. Most effective. |
| b. Not declared, default | Aligned with the 1^{st} Use, similar to a sensitive data's 1^{st} Use. |
| initiated at 1^{st} Use | |
| c. Run-time Declaration | DECL may be missed (unless manual code review), but 1^{st} Use |
| | will be caught and from then on, be handled just like a |
| | sensitive data. |
| d. Conditionally Declared | Lexical scan will catch it, qualified by the pre-condition. |
| 6. Usage: Destroyed - | |
| how | |
| a. Release based Destroy | Release may not secure wipe the memory. Implement a Tail |
| | Trim, with a Secure Wipe. Most effective. |
| b. Not destroyed | Implement a Tail Trim, with a Secure Wipe. Most effective. |
| lexically, just stopped | |
| using it. Garbage | |
| Collector destroys it | |
| c. Explicitly value | This is the ideal scenario. The programmer has already done |
| overwritten with random | what a Secure Wipe is supposed to do. Nothing more to be |
| byte stream | done. |

### 7.4 Net Impact to the Detection, Non invasive Mitigation and Invasive Mitigation

We finalize the net impact to the 3 phases of Data in Use Risk reduction, namely Detection, Mitigation (Non Invasive) and Mitigation (Invasive).

### 7.4.1 Detection Phase

Sensitive data, as they are lexically quoted and provided by the stakeholders, is always (100%) accurately detected. The detection process is: Deterministic and precise

Intermediate variables can be either: (a) Completely irrelevant (never carries sensitive data), or (b) carries sensitive data. Data Flow Graph (DFG) and Control Flow Graph (CFG) analysis puts “sensitive or not” mark on intermediate variables.
DFG finds if any sensitive data has a R/W from/to an intermediate variable
CFG finds if any sensitive data makes a Control path value determination to an intermediate variable

However, the DFG/CFG process may have run-time ambiguities. Hence, (sensitive or not identification of) intermediate variable may be Imprecise. False Positive and/or False Negative possibilities exist. It is not a precise and deterministic process. Manual code review and inspection are recommended.

### 7.4.2 Non Invasive Mitigation Phase

Non invasive mitigation for sensitive data is: (a) Gap threshold driven, and (b) precise and deterministic.

However, non invasive mitigation for intermediate (sensitive data holding) variables may have the following characteristics:
Issue no 1: May not detect all, may overshoot some possibilities of FP and FN
Issue no 2: May vary from as close to precise (for local usage), to Gap threshold based treatment like a sensitive data
Issue no 3: Destroy may be inadequate, requiring secure Wipe

### 7.4.3 Invasive Mitigation Phase

Invasive mitigation for sensitive data utilizes the overall Program Dependency Graph (PDG) and optimizations thereof. It is precise and deterministic. It utilizes the Gap threshold based treatment, like in the non invasive mitigation approach.

However, invasive mitigation for intermediate (sensitive data holding) variables may have the following characteristics:
Issue no 1: May not detect all, may overshoot some possibilities of FP and FN
Issue no 2: May vary from as close to precise (for local usage), to Gap threshold based treatment like a sensitive data
Issue no 3: Frequency of usage. Possible to optimize in invasive mitigation
Issue no 4: Destroy may be inadequate, requiring secure Wipe

### 8. Framework of Crypto Hardness

First, we present two metrices to capture the Data in Use risk exposure, and cost of mitigation. Then, we demonstrate that a third attribute is missing from our assessment-namely, how hard the Crypto algorithms ought to be? Is it always a fixed and static level, or does it vary based upon the amount of Ciphertext exposure that could be available under the specific application circumstances. We demonstrate that it is the latter, and not the former. In doing so, we derive certain variability options in the selection of the Crypto algorithms. The term ‘Crypto’ in this context should be interpreted broadly, it may not be Cryptography always, it may even be a Data Protection Method such as Masking or Obfuscation.

### 8.1 Exposure Metric

We compute cumulative Exposure as the sum of all gap lines between pairwise Uses of the sensitive data.
If the gap between the j^{th} and (j+1)^{st} Use occurrences exceeds (E+D), then
   The Data in Use Risk reduction/Mitigation algorithm would have inserted an encryption immediately after the j^{th} Use occurrence, and another decryption immediately before the (j+1)^{st} Use occurrence.
   As a result, the cumulative Exposure is increased by a fixed (E+D) amount, E due to the code lines in the encryption module, and D due to the code lines in the decryption module.
If the gap between the j^{th} and (j+1)^{st} Use occurrences does not exceed (E+D), then
   There will be no such encryption after (the j^{th} Use occurrence), and decryption (before the (j+1)^{st} Use occurrence) inserted.
   As a result, the cumulative Exposure is increased by the variable gap.
   The cumulative Exposure can be normalized by the total number of Use occurrences, at individual metric level, or at the combined (with Cost) metric level, see below.

### 8.2 Cost Metric

Next, we compute cumulative Cost (as incremental execution delay) as the sum of all additional encryption and decryption operations required.
If the gap between the j^{th} and (j+1)^{st} Use occurrences exceeds (E+D), then Cost+=2, indicating that one additional encryption and one additional decryption became part of the execution timeline.
If the gap between the j^{th} and (j+1)^{st} Use occurrences does not exceed (E+D), then Cost remains unchanged.
The cumulative Cost can be normalized by the total number of Use occurrences, at individual metric level, or at the combined (with Exposure) metric level, see below.

Together, these two Metrics can be defined as

| | | |
|---|---|---|
| Initialization | Exposure = 0 | Cost = 0 |

Iteration (for each pair of successive [j^{th} and (j + 1)^{st}] Uses)

| | | |
|---|---|---|
| gap between the j^{th} and | Exposure += | Cost += 2 |
| (j + 1)^{st} Use occurrences > | E + D | |
| (E + D) | | |
| gap between the j^{th} and | Exposure += | Cost |
| (j + 1)^{st} Use occurrences ≤ | gap | unchanged |
| (E + D) | | |

Combined Metric: Because both Exposure and Cost accrue in the same direction, i.e., increase in either indicates deterioration and decrease in either indicates improvement, we combine these two metrics using addition, multiplication and exponent joiner (as opposed to subtraction and division). A weight (w) is used to provide scale factor between then. Two arithmetic options are proposed below:
Option 1: Exposure+w*Cost
Option 2: Exposure+Cost^{w}

Finally, the combined Metric needs to be normalized, as follows:

$$\frac{Combined Metric [ ( Option 1 ) or ( Option 2 ) ]}{Total number of Use Occurrences}$$

### 8.3 Framework for Crypto (Data Protection Method) Hardness

The process of insertion of an Encryption after the previous Use and a Decryption before the immediate next Use, increases the Data in Use attack surface or Risk by (E+D) in each step, where E & D are in lines of code. In our review of the Java crypto library, E & D are in the ranges of ˜20 each, i.e., approximately 20 high (Java) level lines of code. The Cost metric counts each one of Encryption and Decryption as unitary cost item, and increases the Cost value by 2 every time the pair of Encryption and Decryption is invoked.

But, the scale factor question remains unaddressed. Is the Encryption (or, Decryption) deployed for (a) [Data in Use] Heap the same complexity as the Encryption (or, Decryption) deployed for (b) [Data at Rest] Database fields or records, (c) [Data in Motion] TLS packets? If yes, then a common scale factor can be uniformly used for all encryptions and decryptions. If not, then disparate sets of encryption(s) and decryption(s) are required.

This subsection develops the scale factor model for encryption and decryption. We demonstrate that 2 sets of encryption and decryptions are required—High complexity and cost, versus Low complexity and cost.
[One—High Complexity:] where the amount of Ciphertext data available for cryptanalysis is sufficiently large (permitting cryptanalysis of adequate capacity, which in turn necessitates the encryption algorithms to be sufficiently hardened),
[Two—Low Complexity:] And, the other where the amount of Ciphertext data available for cryptanalysis is small (disallowing cryptanalysis of adequate capacity, which in turn relieves the encryption algorithm from the requirement to be sufficiently hardened).

### 8.4 Exposure Volume (EV)—Amount of Data Available for Cryptanalysis

The amount of data available for cryptanalysis is a function of two parameters—(a) how much Ciphertext data is available (and, being disclosed to the attacker) at a single snapshot (=Snapshot Size), and (b) for how long (aka. Duration) the attacker may be able to covertly keep collecting the snapshots before a security appliance detects the intrusion and cuts off the covert listen in capability, and resets the encryption Keys.

FIG. 20: Deleted. See Drawings file for FIG. 20.

This is shown in FIG. 20. The x-axis is Duration, from Start (when the covert listening started) till the End (when the security appliances or using some other means the attack was detected, apprehended and Keys reset). The y-axis is Snapshot Size.

We discuss below that for different categories of Data Security, namely Data in Use, Data at Rest and Data in Motion—the Exposure Volume (EV) varies significantly. Hence, for the low EV values—a lighter/simpler cryptographic solution is adequate, whereas, for the high EV values the regular industry standard heavyweight crypto algorithms are required.

### 8.5 EV for Data in Use, Data at Rest and Data in Motion

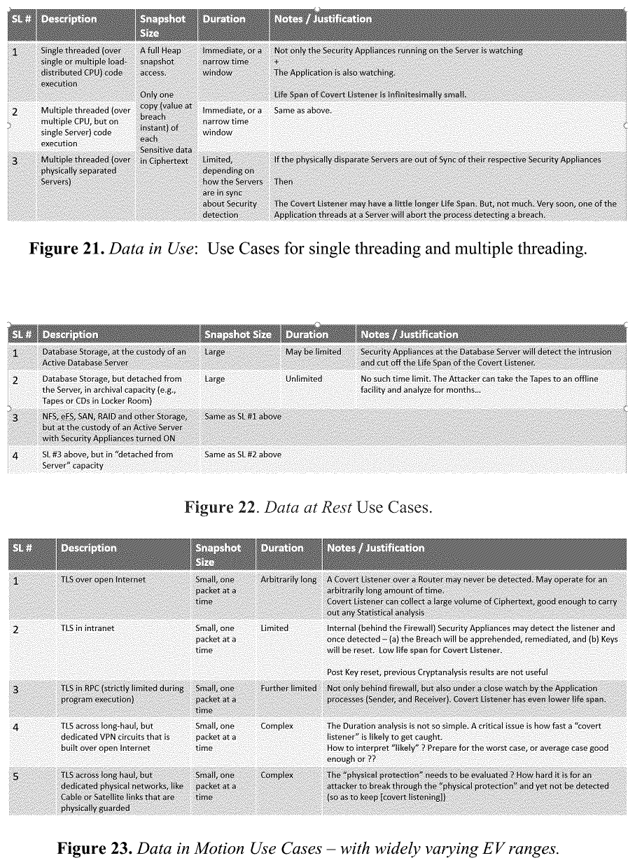

FIG. 21 shows 3 Use Cases for Data in Use. There are two observations. (A) Because the Heap is so close to the Application in real-time execution, and furthermore because the computer memory is so interior and secluded from outside (open internet) world, any attack onto the Heap is likely to get instantly (or, near instantly) detected. The detection may happen via a security appliance installed at the same Server, or the Application watching its own performance from within the code, or a combination. Hence, the Duration is small, if not a single instant of time. (B) at each snapshot, only a single value of each sensitive data is going to be available. It is the value (of the sensitive data) at that point in time. So, the amount of data available in each Snapshot (specific to a particular sensitive data) is just one.

This “one” data value—multiplied by a small covert listen in window, creates a rather small EV. If one extends this argument by including all the sensitive data values (not just “one”), then the EV would have a multiplier, but that multiplier is not in millions or tens of thousands or even in thousands. Most programmers do not deal with more than a handful of sensitive data in a code. As an example, a database may have millions of records, but when a program reads the records, it will usually be one or a few at a time, so the number of sensitive data inside the code will be a few.

FIG. 21: Deleted. See Drawings file for FIG. 21.

Next, we review the Data at Rest Use Cases, as shown in FIG. 22 below. Observations to make include: (a) the Snapshot Size may be arbitrarily large, as indeed the Database contains a lot of data, and (b) the Duration may also be large to potentially unlimited. Thus, the EV is large to potentially infinite.

FIG. 22: Deleted. See Drawings file for FIG. 22.

Third, we review the Data in Motion Use Cases (see FIG. 23). Unlike Data in Use (which is clearly ultra small EV) and Data at Rest (which is clearly large EV)—the case for the Data in Motion can be of either types. For open internet communication, the Duration can be potentially infinite. Whereas, for intra-Server communication, the Duration may be small, with a high detection possibility similar to the Data in Use Use Cases. The Snapshot Size is small, being one Ciphertext packet at a time.

Consequently, the EV can be anywhere from large to small, depending on the Use Case.

FIG. 23: Deleted. See Drawings file for FIG. 23.

### 8.6 Two Tiers of EV: Tier 1 and Tier 2

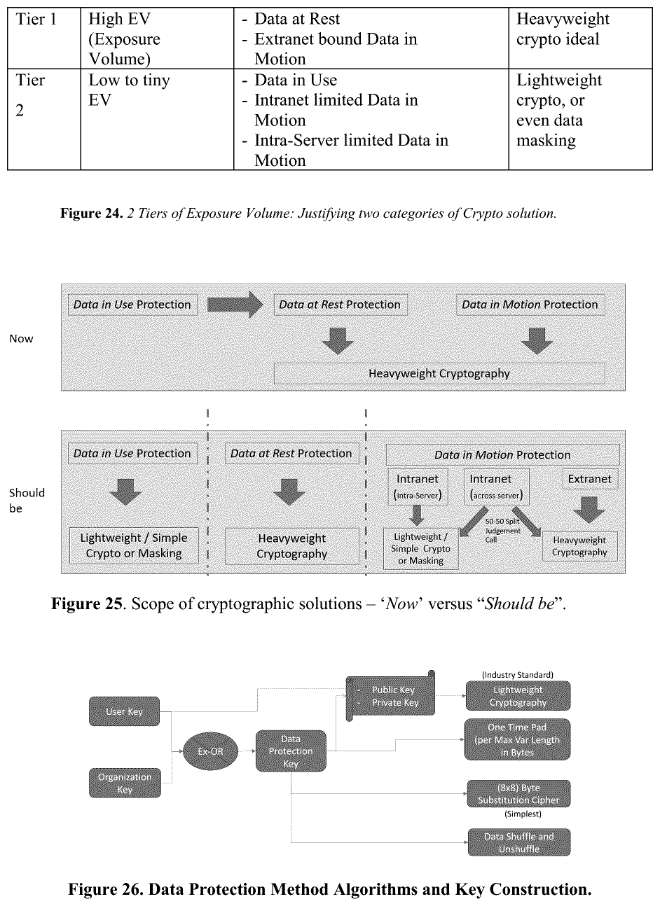

Combining the observations in the 3 sets of Use Cases above, we note that there are two tiers of EV values. Tier 1 is with large EV, and it applies to Data at Rest and certain extranet Data in Motion applications. Tier 2 is with small to tiny EV, and it applies to Data in Use and certain intranet Data in Motion applications. This is shown in FIG. 24 below.

FIG. 24: Deleted. See Drawings file for FIG. 24.

### 8.7 Combined Visual: Current Versus Should-Be

FIG. 25 combines the above observations into a single visual. The upper part is the current industry standard, aka. “Now”. Data in Use is not separately treated, but funneled through Data at Rest protection solution. All 3 of the Data Security protections use the Heavyweight Crypto technology, as is the current industry standard.

FIG. 25: Deleted. See Drawings file for FIG. 25.

The lower part shows the EV range differentiated solution space, aka. “Should be”. Data in Use is clearly in the lightweight (or, even masking) category. Data at Rest is clearly in the opposite, i.e., Heavyweight category. Data in Motion is in the “it depends” category. For extranet communication, it is clearly in Heavyweight category. For intranet and that too within the same server (i.e., intra-Server) communication, it is clearly in the Lightweight or Masking category. For intranet but server to server communication (i.e., traffic that is on the LAN, but inside the firewall), one could argue in either way. Heavyweight encryption may be deployed, on the safety's sake. Or, lightweight and masking solutions can be deployed, to benefit the performance and cost arguments.

### 8.8 Proposed Key Generation Approach

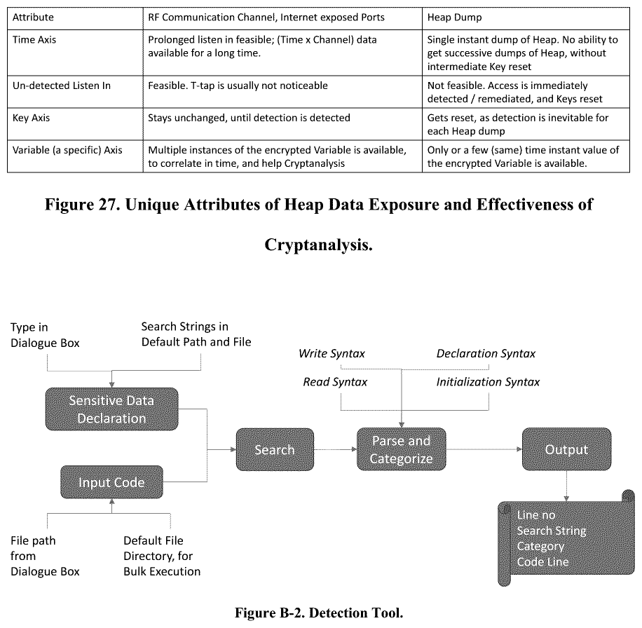

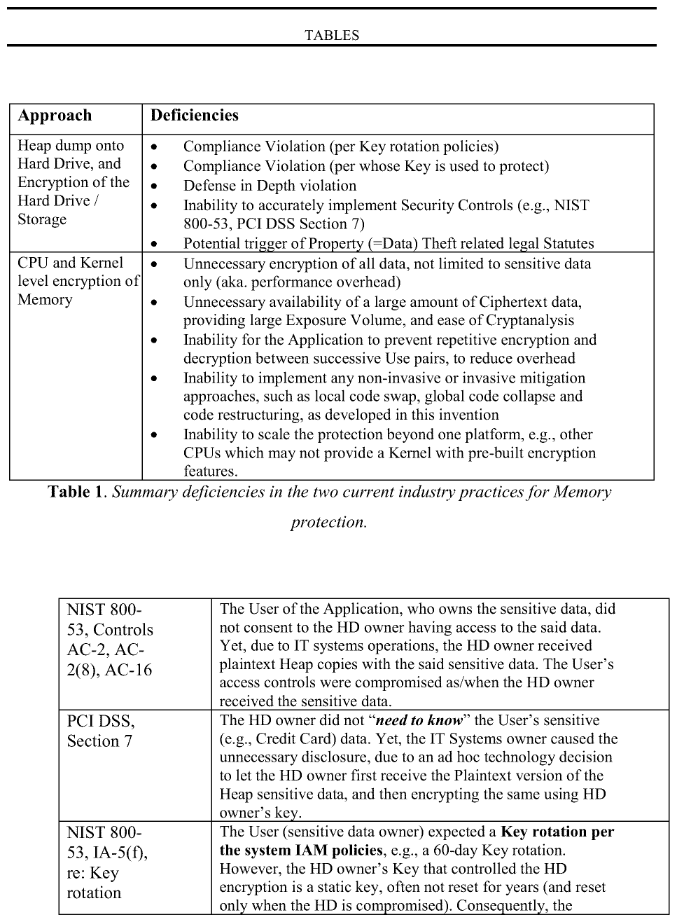

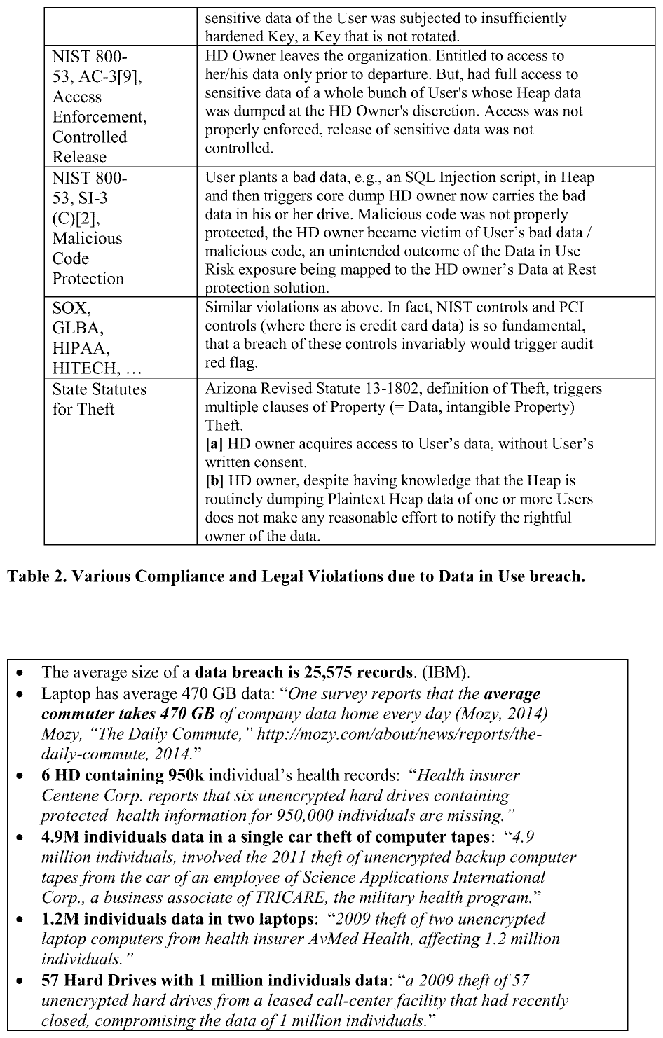

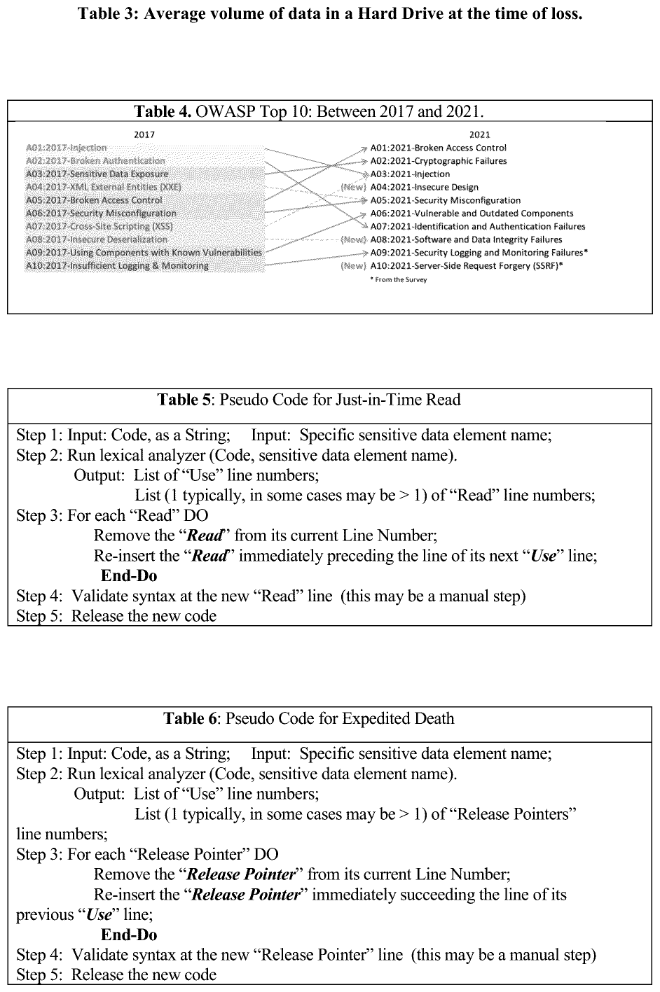

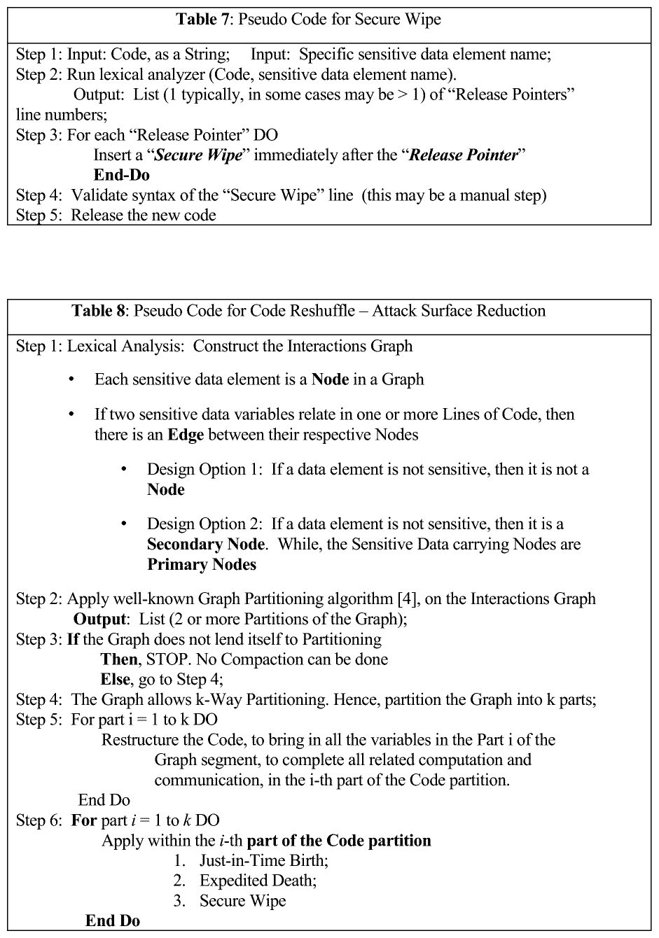

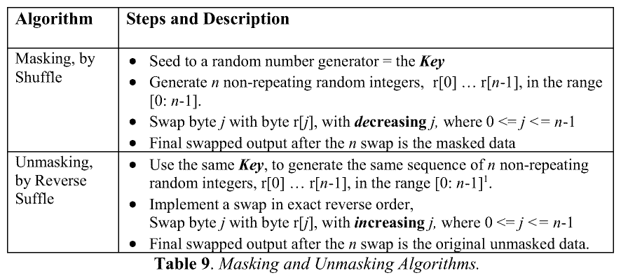

FIG. 26 shows the Data Protection Methods components at a design level, which combines both encryption and data masking, obfuscation. The purpose of this invention is not to reinvent many well-known cryptographic algorithms. However, this invention identifies certain unique attributes of the Heap data exposure, and thereby justify certain simplistic encryption algorithms as well as data masking and obfuscation. In addition to Data Masking and Obfuscation, three specific encryption algorithms are shown, plus Data Masking algorithm is shown starting with the simplest (8×8) Substitution cipher, where every byte is substituted by the cipher table. Normally, and ordinarily use of a substitution cipher would be entirely unacceptable, as it is so easy to break by cryptanalysis. However, the Heap exposure is a unique application, where cryptanalysis may not be as effective as it is for open communication channels or TCP/IP ports.

FIG. 26: Deleted. See Drawings file for FIG. 26.

The second algorithm is a One-Time Pad, which is theoretically known to be the most secure, as long as certain conditions are met, one of which is a 1-time application only. This condition is ideally suited for Heap data exposure, as each exposure carries a one-time data snapshot only, and the One-Time Pad is replaced immediately after exposure. The One-Time Pad, specific to each sensitive data, is selected each time by a pseudorandom number generator with byte length sufficient to exceed the byte length of sensitive data variable.

The third algorithm is Light Weight Cryptography, an evolving standard from NIST with original design from Korean sources. It follows an asymmetric key cryptography structure, and is an industry standard in algorithmic strength.

The fourth algorithm is a fogger based Data Masking solution. Normal industry practice in Data Masking is a one way flow, i.e., take the sensitive data and convert it to an unintelligible variant so that it cannot be easily comprehended, if disclosed. The unintelligible version can be used for Testing, placeholder databases, etc. However, our application is a two way flow, we not only need to transform the sensitive data to an unintelligible format, we also need to implement the reverse, i.e., bring back the unintelligible formatted data back to the original value of the sensitive data. This two way flow process is very similar to encryption and decryption, except it is much lighter weight, and faster to execute.

This invention proposed a Shuffle and Unshuffle algorithm as follows. Depending on the byte size of the sensitive data, the shuffled items are either at byte level, or at bit level. If the sensitive data has n bytes, then the Masking and Unmasking algorithms are as follows. The algorithm is similar to the Fisher-Yates algorithm [11].

Table 9: Deleted. See Drawings file for Table 9.

The Key construction, as shown in FIG. 26, shows how the User as well as the Organization may reset the Key. The Key used is an Exclusive-OR of the two input keys provided by the User and the Organization. So, if at any point in time, the User suspects or is aware of a breach, the User may reset its Key. Likewise, if the Organization is aware of a breach, the Organization may reset the Key as well. The end result, in ether case, is the same—that a new Key will be used, makingS all previous Cryptanalysis ineffective.

2 (out of the 3) Encryption algorithms (Substitution Cipher and One-Time Pad) are Symmetric, their respective Keys are generated from the (User EX-OR Organization) created Key. The 3rd algorithm is Asymmetric, with both Public Key and Private Key being required, which are generated by an arithmetic operation over the User Key. See FIG. 27 for unique attributes.

FIG. 27: Deleted. See Drawings file for FIG. 27.

Normally, and ordinarily, use of Substitution Cipher would be entirely unacceptable due to the ease with which it can be broken. Likewise, use of One-Time Pad may also be considered impractical, due to repetitive nature of the encryption process around a specific data. However, as shown in FIG. 27, Heap data exposure is a unique application, where the conventional cryptanalysis may not be as effective, which re-ignites the usage of both Substitution Cipher and One-Time Pad. Of course, one can always deploy the industry standard, 2-key system (Asymmetric) Light Weight Cryptography to leverage all the benefits of break-in difficulties of the asymmetric key cryptography algorithms.

### References

1. “Privacy Violation: Heap Inspection”, https://vulncat.fortify.com/en/detail?id=desc.dataflow.java.privacy_violation_heap_inspection; Also see: Guidelines 2-1. Purge Sensitive Information from Exceptions, https://www.oracle.com/java/technologies/javase/seccodeguide.html#2
2. “Comprehensively and Efficiently Protecting the Heap”, Kharbutli et al, Proceedings of the 12th International Conference on Architectural Support for Programming Languages and Operating Systems (ASPLOS XII), October 2006.
3. “Windows Security”, https://docs.microsoft.com/en-us/windows/security/information_protection/bitlocker/bitlocker-device-encryption-overview-windows-10
4. “Graph Partitioning problem”, https://patterns.eecs.berkeley.edu/?page_id=571
5. “Sensitive Data Storage in Improperly Locked Memory”, https://martellosecurity.com/kb/mitre/cwe/591/
6. “Obfuscated Files or Information”, https://attack.mitre.org/techniques/T1027
7. “OWASP Top Ten”, https://owasp.org/www-project-top-ten/
8. “CWE-244: Improper Clearing of Heap Memory Before Release (‘Heap Inspection’)” https://cwe.mitre.org/data/definitions/244.html
9. “NIST 800-88 VS DoD 5220.22-M What Is The Best Method?” https://www.sipicorp.com/wp-content/uploads/2019/09/NIST_vs_DoD_V3.pdf
10. “Multi-Key Total Memory Encryption (MKTME) L”, “Protect Data of Virtual Machines with MKTME on KVM, Huang K, Mktme_kvm_forum_2018.pdf (linux-kvm.org), KVM Forum, 2018.
11. Fisher, Ronald A.; Yates, Frank (1948) [1938]. Statistical tables for biological, agricultural and medical research (3rd ed.). London: Oliver & Boyd. pp. 26-27. OCLC 14222135.
12. Ferrante Jeanne, Ottenstein Karl, “The program dependence graph and its use in optimization”, ACM Transactions on Programming Languages and Systems, Volume 9, Issue 3, pp 319-349, https://doi.org/10.1145/24039.24041
13. Androutsopoulos, Kelly & Clark, D & Harman, Mark & Krinke, Jens & Tratt, Laurence. (2023). Survey of Slicing Finite State Machine Models, https://www.researchgate.net/publication/265005497_Survey_of_Slicing_Finite_State_Machine_Mo dels
14. Eugene L Lawler, Jan Karel Lenstra, Alexander H. G. Rinnooy Kan, David B. Shmoys (1993-01-01). “Chapter 9 Sequencing and scheduling: Algorithms and complexity”. Handbooks in Operations Research and Management Science. 4:445-522. doi: 10.1016/S0927-0507 (05) 80189-6. ISBN 9780444874726. ISSN 0927-0507.

1. A method where an Application software directly protects its sensitive data by Memory data protection method (DPM) comprising of the following steps
The Application detects the Uses of the sensitive data by lexical scan, and furthermore categorizes the Uses into one of 4 categories, Declaration, Initialization, Read, or Write;
And
By and through the Application's own code lines, the Application protects it's sensitive data in Memory by implementing a data protection (DP) immediately after any Use (while writing the sensitive data to Memory), and a data un-protection (DUP) immediately before the immediate next Use (while reading the same sensitive data from Memory), and maintaining a DP version of the sensitive data at the Memory at all other times;
And
The Application optimizes the repetitive (for the sensitive data) paired “DP after Use & DUP before next Use” steps by comparing the code lines Gap between successive Uses of the sensitive data against the execution cost of DP and DUP, where.
if the Gap is less than or equal to (≤) the cost of (DP+DUP) then the Application omits the paired “DP after Use & DUP before next Use” steps,
And
if the Gap is larger than the cost of (DP+DUP) then the Application inserts the paired “DP after Use & DUP before next Use” steps.

2. The method of claim 1, where the Application further reduces the Gap between successive Use lines of code (for a sensitive data) by the following steps
Local pairwise code lines swap process, while maintaining Data Flow (DF) and Control Flow (CF) consistencies, to bring successive Use lines (for the same sensitive data) to nearby lines (ideally, immediate next to each other) and thereby minimize the cost of paired “DP after Use & DUP before next Use” steps.

3. The method of claim 2, where the Application further reduces the Gap between successive Use lines of code (for a sensitive data) by the following steps
Constructs a Transitive closure Set of all variables relating to a specific sensitive data (including all intermediate variables),
And
Detects all Use occurrences of anyone or more of the said Transitive closure Set of variables,
And
Implements a collapse of all such detected Use lines, while maintaining CFG (Control Flow Graph) and DFG (Data Flow Graph) accuracies, to bring successive Use lines (for the same sensitive data) closer per code lines to reduce the Gap and thereby reduce the paired “DP after Use & DUP before next Use” activation costs.

4. The method of claim 2, where the Application furthermore executes the following steps
Constructs a top level PDG (Program Dependency Graph) for each sensitive data, and implements code lines for each node of the PDG, strictly serializing the sensitive data items, one PDG at a time,
And
Removes the Input (and, Output) related library references to either before the first PDG node, or after the last PDG node execution to enforce execution optimality per execution of a single machine Job Shop scheduling algorithm.

5. The method of claim 2, where the Application furthermore executes the following steps
Extends the sensitive data Uses to include all the intermediate variables that may obtain one or more copies of the sensitive data during the execution of the program,
And
Detects the Uses of the intermediate variables either by Lexical scan (for precise matches) or by code inspection (for imprecise matches).

6. The method of claim 2, where the Application furthermore executes the following steps
Implements a secure wipe using random bit stream post last Use of the sensitive data in the code lines,
And
Implements a random bit stream initialization prior to the first Use of the sensitive data in the code lines.

7. The method of claim 1, where the Application furthermore selects a DP and DUP method from a list of cryptographic algorithms and data masking and data obfuscation technologies, comprising of the following steps
Computation of Exposure Volume as a multiplication of the amount of Ciphertext that is likely to be available to an attacker during a single breach instant, and the amount of time an attacker may covertly listen into the breach instances before being apprehended and keys being reset;
And
Election of a DP & DUP algorithm as a function of the Exposure Volume, comprising of the following steps
The lowest Exposure Volume permissive of electing data masking and data obfuscation solutions,
And
Progressively higher Exposure Volume electing respectively from the list of: Substitution cipher, Transpose cipher, One-time (8×8 byte) pad, Lightweight cryptography, and AES class of industry standard cryptographic algorithms.

8. A system where an Application software directly protects its sensitive data by Memory DPM comprising of the following components
The Application detecting the Uses of the sensitive data by lexical scan, and furthermore categorizes the Uses into one of 4 categories, Declaration, Initialization, Read, or Write;
And
By and through the Application's own code lines, the Application protecting it's sensitive data in Memory by implementing a DP immediately after any Use (while writing the sensitive data to Memory), and a DUP immediately before the immediate next Use (while reading the same sensitive data from Memory), and maintaining a DP version of the sensitive data at the Memory at all other times;
And
The Application optimizing the repetitive (for the sensitive data) paired “DP after Use & DUP before next Use” steps by comparing the code lines Gap between successive Uses of the sensitive data against the execution cost of DP and DUP, where.
if the Gap is less than or equal to (≤) the cost of (DP+DUP) then the Application omits the paired “DP after Use & DUP before next Use” steps,
And
if the Gap is larger than the cost of (DP+DUP) then the Application inserts the paired “DP after Use & DUP before next Use” steps.

9. The system of claim 8, where the Application further reduces the Gap between successive Use lines of code (for a sensitive data) by the following components
Local pairwise code lines swapping process, while maintaining Data Flow (DF) and Control Flow (CF) consistencies, to bring successive Use lines (for the same sensitive data) to nearby lines (ideally, immediate next to each other) and thereby minimize the cost of paired “DP after Use & DUP before next Use” steps.

10. The system of claim 9, where the Application further reduces the Gap between successive Use lines of code (for a sensitive data) by the following components
Constructing a Transitive closure Set of all variables relating to a specific sensitive data (including all intermediate variables),
And
Detecting all Use occurrences of anyone or more of the said Transitive closure Set of variables,
And
Implementing a collapse of all such detected Use lines, while maintaining CFG (Control Flow Graph) and DFG (Data Flow Graph) accuracies, to bring successive Use lines (for the same sensitive data) closer per code lines to reduce the Gap and thereby reduce the paired “DP after Use & DUP before next Use” activation costs.

11. The system of claim 9, where the Application furthermore comprises of the following components
Constructing a top level PDG (Program Dependency Graph) for each sensitive data, and implements code lines for each node of the PDG, strictly serializing the sensitive data items, one PDG at a time,
And
Removing the Input (and, Output) related library references to either before the first PDG node, or after the last PDG node execution to enforce execution optimality per execution of a single machine Job Shop scheduling algorithm.

12. The system of claim 9, where the Application furthermore comprises of the following components
Extending the sensitive data Uses to include all the intermediate variables that may obtain one or more copies of the sensitive data during the execution of the program,
And
Detecting the Uses of the intermediate variables either by Lexical scan (for precise matches) or by code inspection (for imprecise matches).

13. The system of claim 9, where the Application furthermore comprises of the following components
Implementing a secure wipe using random bit stream post last Use of the sensitive data in the code lines,
And
Implementing a random bit stream initialization prior to the first Use of the sensitive data in the code lines.

14. The system of claim 8, where the Application furthermore selects a DP and DUP method from a list of cryptographic algorithms and data masking and data obfuscation technologies, comprising of the following components
Computes Exposure Volume as a multiplication of the amount of Ciphertext that is likely to be available to an attacker during a single breach instant, and the amount of time an attacker may covertly listen into the breach instances before being apprehended and keys being reset;
And
Elects a DP & DUP algorithm as a function of the Exposure Volume, comprising of the following components
The lowest Exposure Volume permissive of electing data masking and data obfuscation solutions,
And
Progressively higher Exposure Volume electing respectively from the list of: Substitution cipher, Transpose cipher, One-time (8×8 byte) pad, Lightweight cryptography, and AES class of industry standard cryptographic algorithms.

15. A non-transitory computer readable medium storing instructions for an Application software that directly protects its sensitive data by Memory DPM comprising of the following media.
The Application detecting the Uses of the sensitive data by lexical scan, and furthermore categorizes the Uses into one of 4 categories, Declaration, Initialization, Read, or Write;
And
By and through the Application's own code lines, the Application protecting it's sensitive data in Memory by implementing a DP immediately after any Use (while writing the sensitive data to Memory), and a DUP immediately before the immediate next Use (while reading the same sensitive data from Memory), and maintaining a DP version of the sensitive data at the Memory at all other times;
And
The Application optimizing the repetitive (for the sensitive data) paired “DP after Use & DUP before next Use” steps by comparing the code lines Gap between successive Uses of the sensitive data against the execution cost of DP and DUP, where.
if the Gap is less than or equal to (≤) the cost of (DP+DUP) then the Application omits the paired “DP after Use & DUP before next Use” steps,
And
if the Gap is larger than the cost of (DP+DUP) then the Application inserts the paired “DP after Use & DUP before next Use” steps.

16. The media of claim 15, where the Application further reduces the Gap between successive Use lines of code (for a sensitive data) by the following media
Local pairwise code lines swapping process, while maintaining Data Flow (DF) and Control Flow (CF) consistencies, to bring successive Use lines (for the same sensitive data) to nearby lines (ideally, immediate next to each other) and thereby minimize the cost of paired “DP after Use & DUP before next Use” steps.

17. The media of claim 16, where the Application further reduces the Gap between successive Use lines of code (for a sensitive data) by the following media
Constructing a Transitive closure Set of all variables relating to a specific sensitive data (including all intermediate variables),
And
Detecting all Use occurrences of anyone or more of the said Transitive closure Set of variables,
And
Implementing a collapse of all such detected Use lines, while maintaining CFG (Control Flow Graph) and DFG (Data Flow Graph) accuracies, to bring successive Use lines (for the same sensitive data) closer per code lines to reduce the Gap and thereby reduce the paired “DP after Use & DUP before next Use” activation costs.

18. The media of claim 16, where the Application furthermore comprises of the following media
Constructing a top level PDG (Program Dependency Graph) for each sensitive data, and implements code lines for each node of the PDG, strictly serializing the sensitive data items, one PDG at a time,
And
Removing the Input (and, Output) related library references to either before the first PDG node, or after the last PDG node execution to enforce execution optimality per execution of a single machine Job Shop scheduling algorithm.

19. The media of claim 16, where the Application furthermore comprises of the following media
Extending the sensitive data Uses to include all the intermediate variables that may obtain one or more copies of the sensitive data during the execution of the program,
And
Detecting the Uses of the intermediate variables either by Lexical scan (for precise matches) or by code inspection (for imprecise matches).

20. The media of claim 16, where the Application furthermore comprises of the following media
Implementing a secure wipe using random bit stream post last Use of the sensitive data in the code lines,
And
Implementing a random bit stream initialization prior to the first Use of the sensitive data in the code lines.

21. The media of claim 15, where the Application furthermore selects a DP and DUP method from a list of cryptographic algorithms and data masking and data obfuscation technologies, comprising of the following media.
Computes Exposure Volume as a multiplication of the amount of Ciphertext that is likely to be available to an attacker during a single breach instant, and the amount of time an attacker may covertly listen into the breach instances before being apprehended and keys being reset;
And
Elects a DP & DUP algorithm as a function of the Exposure Volume, comprising of the following media
The lowest Exposure Volume permissive of electing data masking and data obfuscation solutions,
And
Progressively higher Exposure Volume electing respectively from the list of: Substitution cipher, Transpose cipher, One-time (8×8 byte) pad, Lightweight cryptography, and AES class of industry standard cryptographic algorithms.
